(19) United States
(12) Patent Application Publication
(10) Pub. No.: US 2008/0274911 A1
(43) Pub. Date: Nov. 6, 2008

(54) Gene expression profiling based identification of genomic signature of high-risk multiple myeloma and uses thereof

(76) Inventors: Bart E. Burington, Oakland, CA (US); John D. Shaughnessy, Roland, AR (US); Yiming Zhou, Little Rock, AR (US); Fenghuang Zhan, Little Rock, AR (US); Bart Barlogle, Little Rock, AR (US)

Correspondence Address: Benjamin Aaron Adler;ADLER & ASSOCIATES, 8011 Candle Lane, Houston, TX, 77071, US

(21) Appl. No.: 12/148,985

(22) Filed: Apr. 24, 2008

Related U.S. Application Data
(63) Continuation-in-part of application No. 11/983,113, filed on Nov. 7, 2007.
(60) Provisional application No. 60/857,456, filed on Nov. 7, 2006.

(51) Int. Cl. C40B 30/04; G06G 7/48

(52) U.S. Cl. 506/9; 703/11

(57) ABSTRACT

The present invention discloses a method of applying novel bioinformatics and computational methodologies to data generated by high-resolution genome-wide comparative genomic hybridization and gene expression profiling on CD138-sorted plasma cells from a cohort of 92 newly diagnosed multiple myeloma patients treated with high dose chemotherapy and stem cell rescue. The results revealed that gains the q arm and loss of the p arm of chromosome 1 were highly correlated with altered expression of resident genes in this chromosome, with these changes strongly correlated with 1) risk of death from disease progression, 2) a gene expression based proliferation index, and 3) a recently described gene expression-based high-risk index. Importantly, we also found a strong correlation between copy number gains of 8q24, and increased expression of Argonate 2 (AGO2) a gene coding for a master regulator of microRNA expression and maturation, also being significantly correlated with outcome. Our novel findings significantly improve our understanding of the genomic structure of multiple myeloma and its relationship to clinical outcome.

### CROSS-REFERENCE TO RELATED APPLICATION

This is a continuation-in-part of U.S. Ser. No. 11/983,113, filed Nov. 7, 2007, which claims benefit of provisional patent application 60/857,456, filed Nov. 7, 2006, now abandoned.

### FEDERAL FUNDING LEGEND

This invention was created, in part, using funds from the federal government under National Cancer Institute grant CA55819 and CA97513. Consequently, the U.S. government has certain rights in this invention.

### BACKGROUND OF THE INVENTION

1. Field of the Invention

The present invention generally relates to the field of cancer research. More specifically, the present invention relates to the integration of information of somatic cell DNA copy number abnormalities and gene expression profiling to identify genomic signatures specific for high-risk multiple myeloma useful for predicting clinical outcome and survival.

2. Description of the Related Art

Genomic instability is a hallmark of cancer. With the recent advances in comparative genomic hybridization (CGH) (Pinkel and Albertson, 2005a), a deeper understanding of the relationship between somatic cell DNA copy number abnormalities (CNAs) in disease biology has emerged (Pinkel and Albertson, 2005b; Feuk et al, 2006; Sharp et al, 2006; Lupski et al, 2005). Remarkably, DNA copy number abnormalities have recently been discovered in germline DNA within the human population, suggesting that inheritance of such copy number abnormalities may predispose to disease (Sebat et al, 2004; Redon et al, 2006; Tuzun et al, 2005; Iafrate et al, 2004).

Multiple myeloma (MM) is a neoplasm of terminally differentiated B-cells (plasma cells) that home to and expand in the bone marrow causing a constellation of disease manifestations including osteolytic bone destruction, hyercalcemia, immunosuppression, anemia, and end organ damage (Barlogie et al, 2005). Multiple myeloma is the second most frequently occurring hematological cancer in the United States after non-Hodgkin's lymphoma (Barlogie et al, 2005), with an estimated 19,000 new cases diagnosed in 2007, and approximately 50,000 patients currently living with the disease. Despite significant improvement in patient outcome as a result of the optimal integration of new drugs and therapeutic strategies in the clinical management of the disease, many patients with multiple myeloma relapse and succumb to the disease (Kumar and Anderson, 2005). Importantly, a subset of high-risk disease, defined by gene expression profiles, does not benefit from current therapeutic interventions (Shaughnessy et al, 2007; Zhan et al, 2008). A complete definition of high-risk disease will provide a better means of patient stratification and clinical trial design and also provide the framework for novel therapeutic design.

Unlike in most hematological malignancies, the multiple myeloma genome is often characterized by complex chromosomal abnormalities including structural and numerical rearrangements that are reminiscent of epithelial tumors (Kuehl and Bergsagel, 2002). Errors in normal recombination mechanisms active in B-cells to create a functional immunoglobulin gene result in chromosomal translocations between the immunoglobulin loci and oncogenes on other chromosomes. These rearrangements, likely represent initiating oncogenic events, which lead to constitutive expression of resident oncogenes that come under the influence of powerful immunoglobulin enhancer elements. In multiple myeloma, recurrent translocations involving the CCND1, CCND3, MAF, MAFB and FGFR3/MMSET genes account for approximately 40% of tumors (Kuehl and Bergsagel, 2002), and also define molecular subtypes of disease (Zhan et al, 2006). Hyperdiploidy, typically associated with gains of chromosomes 3, 5, 7, 9, 11, 15, and 19, arising through unknown mechanisms, defines another 60% of multiple myeloma disease. Additional copy number alterations, including loss of chromosomes 1p and 13, and gains of 1q21, are also characteristic of multiple myeloma plasma cells, and are important factors affecting disease pathogenesis and prognosis (Fonseca et al, 2004; Liebisch and Dohner, 2006). Gains of the long arm of chromosome 1 (1q) are one of the most common genetic abnormalities in myeloma (Avet-Loiseau et al, 1997). Tandem duplications and jumping segmental duplications of the chromosome 1q band, resulting from decondensation of pericentromeric heterochromatin, are frequently associated with disease progression (Sawyer et al, 1998; Le Baccon et al, 2001; Sawyer et al, 2005). Using array comparative genomic hybridization on DNA isolated from plasma cells derived from patients with smoldering myeloma, Rosinol and colleagues showed that the risk of conversion to overt disease was linked to gains of 1q21 and loss of chromosome 13 (Rosinol et, 2005). These findings were confirmed by using interphase fluorescence in situ hybridization (FISH) analysis. Additionally, it was demonstrated that gains of 1q21 acquired in symptomatic myeloma were linked to inferior survival and were further amplified at disease relapse (Hanamura et al, 2006). The recognition that many of these abnormalities can be observed in the benign plasma cell dyscrasia, monoclonal gammopathy of undetermined significance (MGUS), suggests that additional genomic changes are required for the development of overt symptomatic disease requiring therapy.

It is speculated that copy number abnormalities might represent important events in disease progression. Ploidy changes in multiple myeloma have been primarily observed through either low resolution approaches, such as metaphase G-banding karyotyping, which might miss submicroscopic changes and is unable to accurately define DNA breakpoints, or locus specific studies such as interphase or metaphase fluorescence in situ hybridization (FISH), which focuses on a few pre-defined, small, specific regions on chromosomes. Array-based comparative genomic hybridization is a recently developed technique that provides the potential to simultaneously investigate with high-resolution copy number abnormalities across the whole genome (Barrett et al, 2004; Pollack et al, 1999; Pinkel et al, 1998). With the power of this emerging technique, researchers have confirmed known abnormalities and also found novel genomic aberrations in a variety of cancers. Among those novel aberrations discovered, some are benign while the others are related to disease initiation or progression. These two groups of lesions, so called ‘drivers’ and ‘passengers’, need to be differentiated before being used to search for mechanisms underlying disease pathobiology and/or in clinical diagnosis and prognosis (Lee et al, 2007).

The direct effect of DNA copy number on cellular phenotype is to interfere with gene expression by either altering gene dosage, disrupting gene sequences, or perturbing cis-elements in promoter or enhancer regions (Feuk et al, 2006; Phillips et al, 2001; Platzer et al, 2002; Pollack et al, 2002; Hyman et al, 2002; Orsetti et al, 2004; Stallings, 2007; Auer et al, 2007; Gao et al, 2007). Copy number abnormalities have been shown to contribute to ˜17% of gene expression variation in normal human population and has little overlap with the contribution of single nucleotide polymorphisms (SNPs) (Stranger et al, 2007). Additionally, more than half of highly amplified genes were demonstrated to exhibit moderately or highly elevated gene expression in breast cancer (Pollack et al, 2002). Thus, considering the high number of copy number abnormalities in multiple myeloma cells, it is likely that copy number abnormalities play a pivotal role in disease initiation and progression.

Cigudosa et al (1998), Gutiérrez et al (2004), and Avet-Loiseau et al (1997) first applied traditional comparative genomic hybridization approaches (Houldsworth and Chaganti, 1994), and expanded our knowledge about the nature of chromosome instability in multiple myeloma. Walker et al (2006) applied single nucleotide polymorphism (SNP)-based mapping array to investigate DNA copy number and loss of heterozygosity (LOH) in this disease. We previously used interphase fluorescence in situ hybridization analysis on more than 400 cases of newly diagnosed disease to show gains of 1q, while not seen in monoclonal gammopathy of undetermined significance, when present in smoldering multiple myeloma, was associated with increased risk of progression to overt multiple myeloma, and when present in newly diagnosed symptomatic disease was associated with a poor outcome following autologous stem cell transplantation (Hanamura et al, 2006). Importantly, longitudinal studies on this cohort revealed that a percentage of cells with 1q gains could increase overtime within a given patient, suggesting this event was related to disease progression and clonal evolution. Using array comparative genomic hybridization on a small cohort of 67 cases we used non-negative matrix factorization techniques to identify two subtypes of hyperdiploid disease, one with evidence of 1q gains, and that this form of hyperdiploid disease was associated with shorter event-free survival (Carrasco et al, 2006). Consistent with these data, we recently reported on the use of gene expression profiling to identify a gene expression signature of high-risk disease dominated by elevated expression of genes mapping to chromosome 1q and reduced expression of genes mapping to 1p (Shaughnessy et al, 2007).

We also investigated potential mechanisms of genome instability in multiple myeloma cells. The results of the study revealed that copy number alterations in chromosome 1q and 1p were highly correlated with gene expression changes and these changes also strongly correlated with risk of death from disease progression, a gene expression based proliferation index and a recently described gene expression-based high-risk index. Importantly, we also found that copy number gains and increased expression of AGO2, a gene mapping to 8q24 and coding for a protein exclusively functioning as a master regulator of microRNA expression and maturation, was also significantly correlated with outcome.

Thus, the prior art is deficient in copy number abnormalities and expression profiling of genes to identify distinct and prognostically relevant genomic signatures linked to survival for multiple myeloma that contribute to disease progression and can be used to identify high-risk disease and guide therapeutic intervention. The prior art is also deficient in identification of DNA deletions or additions on chromosomes 1 and 8, which are correlated with gene expression patterns that can be used to identify patients experiencing a relapse after being subjected to therapy. The present invention fulfills this long-standing need and desire in the art.

### SUMMARY OF THE INVENTION

The present invention is directed to a method of detecting copy number abnormalities and gene expression profiling to identify genomic signatures linked to survival for a disease. Such a method comprises isolating plasma cells from individuals who suffer from a disease and from individuals who do not suffer from the same disease and nucleic acid is extracted from their plasma cells. The nucleic acid is hybridized to a comparative genomic DNA array and to a gene expression DNA microarray to determine copy number abnormalities and expression levels of genes in the plasma cells. The data is analyzed using bioinformatics and computational methodology and the results of an altered expression of disease candidate genes are indicative of the specific genomic signatures linked to survival for a disease.

The present invention is directed to a method of detecting a high-risk index and increased risk of death from the disease progression of multiple myeloma. Such a method comprises isolating plasma cells from individuals who suffer from the disease and from individuals who do not suffer from multiple myeloma and nucleic acid is extracted from their plasma cells. The nucleic acid is hybridized to a comparative genomic DNA array and to a gene expression DNA microarray to determine copy number abnormalities and expression levels of genes in the plasma cells. The data is analyzed using bioinformatics and computational methodology and the results of an altered expression of disease candidate genes and copy number abnormalities are indicative of a high-risk index and increased risk of death from the disease progression of multiple myeloma.

The present invention is also directed to a method of detecting copy number abnormalities and gene expression alterations at chromosomal location 8q24 and increased expression of the gene Argonaute 2 (AG02). Such a method comprises isolating plasma cells from individuals who suffer from multiple myeloma and from individuals who do not suffer from multiple myeloma and nucleic acid is extracted from their plasma cells. The nucleic acid is hybridized to a comparative genomic DNA array and to a gene expression DNA microarray to determine copy number abnormalities and expression levels of genes in the plasma cells. The data is analyzed using bioinformatics and computational methodology and the results of an altered expression of the gene Argonaute 2 and copy number abnormalities involving gains at 8q24 are linked to a high-risk index and increased risk of death from multiple myeloma.

The present invention is directed to a method of detecting high risk in disease progression of multiple myeloma. Such a method comprises isolating plasma cells from individuals who suffer from the disease and from individuals who do not suffer from multiple myeloma and nucleic acid is extracted from their plasma cells. The nucleic acid is hybridized to a comparative genomic DNA array and to a gene expression DNA microarray to determine copy number abnormalities and expression levels of genes in the plasma cells. The data is analyzed using bioinformatics and computational methodology and the results of an altered expression of disease candidate genes and copy number abnormalities involving loss of chromosome 1p DNA, loss of 1p gene expression, or loss of 1p protein expression are indicative of high risk in disease progression of multiple myeloma.

The present invention is directed to a method of detecting high risk in disease progression of multiple myeloma. Such a method comprises isolating plasma cells from individuals who suffer from the disease and from individuals who do not suffer from multiple myeloma and nucleic acid is extracted from their plasma cells. The nucleic acid is hybridized to a comparative genomic DNA array and to a gene expression DNA microarray to determine copy number abnormalities and expression levels of genes in the plasma cells. The data is analyzed using bioinformatics and computational methodology and the results of an altered expression of disease candidate genes and copy number abnormalities involving gain of chromosome 1q DNA, gain of 1q gene expression, or gain of 1q protein expression are indicative of high risk in disease progression of multiple myeloma.

The present invention is directed to a method of detecting diagnostic, predictive, or therapeutic markers of a disease. Such a method comprises isolating plasma cells from individuals who suffer from a disease and from individuals who do not suffer from the same disease and nucleic acid is extracted from their plasma cells. The nucleic acid of the plasma cells is hybridized to a comparative genomic DNA array and to a gene expression DNA microarray to determine copy number abnormalities and expression levels of genes in the plasma cells. The data is analyzed using bioinformatics and computational methodology and the results of an altered expression of disease candidate genes and copy number abnormalities involving loss of chromosome 1p DNA, loss of 1p gene expression, loss of 1p protein expression, gain of chromosome 1q DNA, gain of 1q gene expression, gain of 1q protein expression, gain of chromosome 8 DNA, gain of 8q gene expression, or gain of 8q protein expression are indicative of detection of diagnostic, predictive, or therapeutic markers of a disease.

The present invention is also directed to a method of detecting copy number abnormalities and gene expression alterations to identify genomic signatures linked to survival for a disease. Such a method comprises isolating plasma cells from individuals who suffer from a disease and from individuals who do not suffer from a disease and nucleic acid is extracted from their plasma cells. The nucleic acid is analyzed to determine copy number abnormalities, expression levels of genes, and chromosomal regions in the plasma cells. The data is analyzed using bioinformatics and computational methodology and the results of copy number abnormalities and gene expression alterations identify genomic signatures linked to survival for a disease.

The present invention is also directed to a kit for the identification of genomic signatures linked to survival specific for a disease. Such a kit comprises an array comparative genomic hybridization DNA microarray and a gene expression DNA microarray to determine copy number abnormalities and expression levels of genes in the plasma cells, and written instructions for extracting nucleic acid from the plasma cells of an individual and hybridizing the nucleic acid to the DNA microarray.

### BRIEF DESCRIPTION OF THE DRAWINGS

FIG. 1 shows a genome-wide heat map of atom regions (ARs) in molecularly-defined multiple myloma subgroups. Dark gray represents gain/amplification and light gray indicates loss/deletion. Atom regions are ordered according to chromosome map positions from p ter to q ter from the largest to smallest autosome then chromosomes X and Y. Samples (rows) were ordered according to a gene expression-based classification as previously described (Zhan et al, 2006). Note the evidence of hyperdiploid features in all classes with the exception of CD-2 subtypes. Also note the evidence of microdeletions in chromosome 2q and 14q in virtually all samples, a phenomenon likely related to immunoglobulin rearrangements that lead to DNA deletions in normal B-cell development.

FIGS. 2A-2C show survival analysis based on copy number abnormalities. FIG. 2A shows chromosomes are ordered from left to right from p ter to q ter from the largest to smallest autosome then chromosomes X and Y. Black points represent those atom regions whose increased copy number is related to poor outcome. Red points represent atom regions whose reduced copy number is related to poor outcome. The upper panel (y>1) represents the hazard ratio and the lower panel (y<0) represents log 10 P value of the log-rank test. Upper red line is 1. The lower red line is at −6.3, which represents the strictest criteria based on the Bonferroni correction method for multiple testing. All hazard ratios greater than 10 were set to be 10. FIG. 2B shows the distribution of length of DNA significantly associated with outcome with statistical significance level of 0.01. FIG. 2C shows the distribution of length of DNA significantly associated with outcome with Bonferroni-corrected statistical significance level of 5.4e-07.

FIG. 3 shows the correlations between outcome and atom regions (ARs) overlapping with copy number variations (CNVs) and atom regions with no copy number variations overlap. X-axis is logarithmic-transformed P value (logP) of log-rank test of atom regions. The red line represents the probability distribution of the logP of atom regions not overlapping with normal copy number variations. The black line represents the probability distribution of logP of atom regions overlapping with normal copy number variations. The two lines have obvious different distribution (p=0.012, one-side Kolmogorov-Smimov test), which means the atom regions not overlapping with normal copy number variations tend to be more associated with disease outcome (smaller P value of log-rank test) than those overlapping with normal copy number variations.

FIGS. 4A-4B show the correlation between array comparative genomic hybridization data and risk index, and proliferation index. Chromosomes are ordered from left to right from p ter to q ter from the largest to smallest autosome then chromosomes X and Y. Red points (boxed with arrow labeled red) indicate the top 100 copy number abnormalities positively correlated and green points (boxed with arrow labeled green) the top 100 copy number abnormalities negatively correlated with FIG. 4A, a gene expression based risk index and FIG. 4B with a proliferation index. Note the significant relationship between gains of 1q and loss of 1p with the risk index and proliferation index. Also note the strong relationship between gains of 8q24 and the risk index but the absence of such a link with the proliferation index.

FIGS. 5A-5G show alterations in EIF2C2/AGO2 are significantly associated with survival in multiple myeloma. FIGS. 5A, 5C, 5E, and 5G show the log-rank p-values at different cutoffs and FIGS. 5B, 5D, 5F, and 5H represent Kaplan-Meier survival curves of overall survival using the optimal cutoffs identified in FIGS. 5A, 5C, 5E, and 5G. The cutoffs go through 5th˜95th percentiles of signal. In FIGS. 5A, 5C, 5E and 5G, the blue curve (marked with arrow labeled blue) represent the density distribution of signals. In FIGS. 5A, 5C, 5E and 5G, the three horizontal lines indicate three different significance levels, black (marked with arrow labeled black) 0.05, green (marked with arrow labeled green) 0.01, and red (marked with arrow labeled red) 0.001. The survival analyses were performed on DNA copy numbers (FIGS. 5A-5B); m-RNA expression levels in same samples with DNA copy numbers data (FIGS. 5C-5D); mRNA expression levels in Total Therapy 2 data set (FIGS. 5E-5F); and mRNA expression levels in Total Therapy 3 data set (FIGS. 5G-5H).

FIG. 6 shows the incidence of atom regions in multiple myeloma. Chromosomes are ordered from left to right from p ter to q ter from the largest to smallest autosome then chromosomes X and Y. The percentage of atom regions (ARs) associated with gains is indicated above the centerline while atom regions associated with losses below the centerline.

FIGS. 7A-7B show survival analysis based on DNA copy number changes at the MYC locus. FIG. 7A shows the log-rank p-values at different cutoffs based on DNA copy number changes and FIG. 7B represents Kaplan-Meier survival curves of overall survival using the optimal cutoff identified in the lefts panels. The cutoffs go through 5th˜95th percentiles of signal. The blue curve (with arrow labeled blue) in FIG. 7A represents the density distribution of signals. In FIG. 7A, the three horizontal lines indicate three different significance levels, black (arrow labeled black) 0.05, green (arrow labeled green) 0.01, and red (arrow labeled red) 0.001. The survival analyses were performed on two atom regions at MYC, ar9837 (FIG. 7A), and ar9838 (FIG. 7B), in the 92 cases studied.

FIG. 8 shows a correlation between MYC DNA copy numbers and MYC mRNA expression levels. Two MYC atom regions (ar) (ar9837 and ar9838) showed strong correlations but their copy number changes were not related to MYC expression levels

FIGS. 9A-9F show survival analysis based on MYC mRNA expression levels. FIGS. 9A, 9C, and 9E show the log-rank p-values at different cutoffs, and FIGS. 9B, 9D and 9F represent Kaplan-Meier survival curves of overall survival using the optimal cutoffs identified in FIGS. 9A, 9C, and 9E. The cutoffs go through 5th˜95th percentiles of signal. In FIGS. 9A, 9C, and 9E the blue curve (arrow labeled blue) represents the density distribution of signals. In FIGS. 9A, 9C, and 9E three horizontal lines indicate three different significance levels, black (arrow labeled black) 0.05, green (arrow labeled green) 0.01, and red (arrow labeled red) 0.001. The survival analyses were performed on FIG. 9A MYC mRNA expression levels in samples also studied by array comparative genomic hybridization; FIG. 9C MYC mRNA expression levels in Total Therapy 2 data set; and FIG. 9E MYC mRNA expression levels in Total Therapy 3 data set.

### DETAILED DESCRIPTION OF THE INVENTION

The present invention contemplates developing and validating a quantitative RT-PCR-based assay that combines these staging/risk-associated genes with molecular subtype/etiology-linked genes identified in the unsupervised molecular classification. Assessment of the expression levels of these genes may provide a simple and powerful molecular-based prognostic test that would eliminate the need for testing so many of the standard variables currently used with limited prognostic implications that are also devoid of drug-able targets. Use of a PCR-based methodology would not only dramatically reduce time and effort expended in fluorescence in-situ hybridization-based analyses but also markedly reduce the quantity of tissue required for analysis. If these gene signatures are unique to myeloma tumor cells, such a test may be useful after treatment to assess minimal residual disease, possibly using peripheral blood as a sample source.

Important implications follow from these observations. First, as varied gene expression patterns often represent distinct underlying biological states of normal (Shaffer et al, 2001) and transformed tissues (Shaffer et al, 2001; Ferrando et al, 2002; Ross et al, 2004), it seems likely that the high-risk signature is related to a biological phenotype of drug resistance and/or rapid relapse in multiple myeloma. Accordingly, this myeloma phenotype deserves further study in order to better characterize the most relevant pathways and identify therapeutic opportunities. The relatively large gene expression datasets employed here provide one avenue to more fully define these tumor types. Second, while some hurdles remain in routine clinical implementation of high-risk stratification, this work highlights that a specific subset of myeloma patients continues to receive minimal benefit from current therapies. A practical method to identify such patients should notably improve patient care. For patients predicted to have a favorable outcome, efforts to minimize toxicity of standard therapy might be indicated, while those predicted to have poor outcome, regardless of the current therapy utilized may be considered for early administration of experimental regimens. The present invention contemplates determining if this tumor gene expression profiling (GEP) and array comparative genomic hybridization model of high-risk could be implemented clinically and if it would be relevant for other front-line regimens, including those that test novel combinations of proteasome inhibitors and/or IMIDs with standard anti-myeloma agents and high dose therapy.

In one embodiment of the present invention, there is provided a method of high-resolution genome-wide comparative genomic hybridization and gene expression profiling to identify genomic signatures linked to survival specific for a disease, comprising: isolating plasma cells from individuals suspected of having multiple myeloma and from individuals not suspected of having multiple myeloma within a population, sorting said plasma cells for CD138-positive population, extracting nucleic acid from said sorted plasma cells, hybridizing the nucleic acid to DNA microarrays for comparative genomic hybridization to determine copy number abnormalities, and hybridizing said nucleic acid to a DNA microarray to determine expression levels of genes in the plasma cells, and applying bioinformatics and computational methodologies to the data generated by said hybridizations, wherein the data results in identification of specific genomic signatures that are linked to survival for said disease.

Such a method may further comprise performing data analysis, within-array normalization, between-array normalization, segmentation, identification of atom regions, multivariate survival analysis, correlation analysis of gene expression level and DNA copy number, sequence analysis, and gene ontology (GO) analysis.

Additionally, the genes may map to chromosomes 1, 2, 3, 5, 7, 8, 9, 11, 12, 13, 14, 15, 16, 17, 18, 19, 20, 21, and 22, and may map to the p or q regions of these chromosomes. Examples of such genes may include, but are not limited to, those that are selected from the group consisting of AGL, AHCTF1, ALG14, ANKRD12, ANKRD15, APH1A, ARHGAP30, ARHGEF2, ARNT, ARPC5, ASAH1, ASPM, ATP8B2, B4GALT3, BCAS2, BLCAP, BOP1, C13orf1, C1orf107, C1orf112, C1orf19, C1orf2, C1orf21, C1orf56, C20orf43, C20orf67, C8orf30A, C8orf40, CACYBP, CAPN2, CCT3, CD48, CD55, CDC42BPA, CDC42SE1, CENPF, CENPL, CEP170, CEPT1, CHD1L, CKS1B, CLCC1, CLK2, CNOT7, COG3, COG6, CREB3L4, CSPP1, CTSK, CYC1, DAP3, DARS2, DBNDD2, DDR2, DEDD, DENND2D, DHRS12, DIS3, DNAJC15, EDEM3, EIF2C2, ELAVL1, ELF1, ELK4, ELL2, ENSA, ENY2, EXOSC4, EYA1, FAF1, FAIM3, FAM20B, FAM49B, FBXL6, FDPS, FLAD1, FLJ10769, FNDC3A, FOXO1, GLRX, GNAI3, GON4L, GPATCH4, GPR89B, HBXIP, IARS2, IL6R, ILF2, ISG20L2, IVNS1ABP, KBTBD6, KBTBD7, KCTD3, KIAA033, KIAA0406, KIAA0460, KIAA0859, KIAA1219, KIF14, KIF21B, KIFAP3, KLHDC9, KLHL20, LPGAT1, LRIG2, LY6E, LY9, MANBAL, MAPBPIP, MEIS2, MET, MPHOSPH8, MRPL9, MRPS14, MRPS21, MRPS31, MSTO1, MTMR11, MYST3, NDUFS2, NEK2, NIT1, NME7, NOS1AP, NUCKS1, NUF2, NVL, OPN3, PBX1, PCM1, PEX19, PHF20L1, PI4 KB, PIGM, PLEC1, PMVK, POGK, POLR3C, PPM2C, PPOX, PRCC, PSMB4, PSMD4, PTDSS1, PUF60, PYCR2, RAB3GAP2, RALBP1, RASSF5, RBM8A, RCBTB1, RCOR3, RGS5, RIPK5, RNPEP, RRP15, RTF1, RWDD3, S100A10, SCAMP3, SCNM1, SDCCAG8, SDHC, SETDB1, SETDB2, SF3B4, SHC1, SNRPE, SP1, SPEF2, SPG7, SS18, STX6, SUGT1, TAGLN2, TARBP1, TARS2, TBCE, THEM4, TIMM17A, TIPRL, TMEM183A, TMEM9, TNKS, TOMM40L, TPM3, TPR, TRAF31P3, TRIM13, TRIM33, TSC22D1, UBAP2L, UBE2T, UCHL5, UCK2, UTP14C, VPS28, VPS36, VPS37A, VPS72, WBP4, WDR47, WDSOF1, YOD1, YWHAB, YWHAZ, ZFP41, ZMYM2, ZNF364, and ZNF687.

Furthermore, the method described herein may predict clinical outcome and survival of an individual, may be effective in selecting treatment for an individual suffering from a disease, may predict post-treatment relapse risk and survival of an individual, may correlate molecular classification of a disease with the genomic signature defining the risk groups, or a combination thereof. The molecular classification may be CD1 and may correlate with high-risk multiple myeloma genomic signature. The CD1 classification may comprise increased expression of MMSET, MAF/MAFB, PROLIFERATION signatures, or a combination thereof. Alternatively, the molecular classification may be CD2 and may correlate with low-risk multiple myeloma genomic signature. The CD2 classification may comprise HYPERDIPLOIDY, LOW BONE DISEASE, CCND1/CCND3 translocations, CD20 expression, or a combination thereof. Additionally, type of disease whose genomic signature is identified using such a method may include but is not limited to symptomatic multiple myeloma, or multiple myeloma.

In another embodiment of the present invention, there is provided a kit for the identification of genomic signatures linked to survival specific for a disease, comprising: DNA microarrays and written instructions for extracting nucleic acid from the plasma cells of an individual, and hybridizing the nucleic acid to DNA microarrays. The DNA microarrays in such a kit may comprise nucleic acid probes complementary to mRNA of genes mapping to chromosomes 1, 2, 3, 5, 7, 8, 9, 11, 12, 13, 14, 15, 16, 17, 18, 19, 20, 21, and 22, and may map to the p or q regions of these chromosomes. Examples of the genes may include but are not limited to those selected from the group consisting of AGL, AHCTF1, ALG14, ANKRD12, ANKRD15, APH1A, ARHGAP30, ARHGEF2, ARNT, ARPC5, ASAH1, ASPM, ATP8B2, B4GALT3, BCAS2, BLCAP, BOP1, C13orf1, C1orf107, C1orf112, C1orf19, C1orf2, C1orf21, C1orf56, C20orf43, C20orf67, C8orf30A, C8orf40, CACYBP, CAPN2, CCT3, CD48, CD55, CDC42BPA, CDC42SE1, CENPF, CENPL, CEP170, CEPT1, CHD1L, CKS1B, CLCC1, CLK2, CNOT7, COG3, COG6, CREB3L4, CSPP1, CTSK, CYC1, DAP3, DARS2, DBNDD2, DDR2, DEDD, DENND2D, DHRS12, DIS3, DNAJC15, EDEM3, EIF2C2, ELAVL1, ELF1, ELK4, ELL2, ENSA, ENY2, EXOSC4, EYA1, FAF1, FAIM3, FAM20B, FAM49B, FBXL6, FDPS, FLAD1, FLJ10769, FNDC3A, FOXO1, GLRX, GNAI3, GON4L, GPATCH4, GPR89B, HBXIP, IARS2, IL6R, ILF2, ISG20L2, IVNS1ABP, KBTBD6, KBTBD7, KCTD3, KIAA0133, KIAA0406, KIAA0460, KIAA0859, KIAA1219, KIF14, KIF21B, KIFAP3, KLHDC9, KLHL20, LPGAT1, LRIG2, LY6E, LY9, MANBAL, MAPBPIP, MEIS2, MET, MPHOSPH8, MRPL9, MRPS14, MRPS21, MRPS31, MSTO1, MTMR11, MYST3, NDUFS2, NEK2, NIT1, NME7, NOS1AP, NUCKS1, NUF2, NVL, OPN3, PBX1, PCM1, PEX19, PHF20L1, PI4KB, PIGM, PLEC1, PMVK, POGK, POLR3C, PPM2C, PPOX, PRCC, PSMB4, PSMD4, PTDSS1, PUF60, PYCR2, RAB3GAP2, RALBP1, RASSF5, RBM8A, RCBTB1, RCOR3, RGS5, RIPK5, RNPEP, RRP15, RTF1, RWDD3, S100A10, SCAMP3, SCNM1, SDCCAG8, SDHC, SETDB1, SETDB2, SF3B4, SHC1, SNRPE, SP1, SPEF2, SPG7, SS18, STX6, SUGT1, TAGLN2, TARBP1, TARS2, TBCE, THEM4, TIMM17A, TIPRL, TMEM183A, TMEM9, TNKS, TOMM40L, TPM3, TPR, TRAF31P3, TRIM13, TRIM33, TSC22D1, UBAP2L, UBE2T, UCHL5, UCK2, UTP14C, VPS28, VPS36, VPS37A, VPS72, WBP4, WDR47, WDSOF1, YOD1, YWHAB, YWHAZ, ZFP41, ZMYM2, ZNF364, and ZNF687.

Additionally, the disease for which the kit is used may include but is not limited to asymptomatic multiple myeloma, symptomatic multiple myeloma, multiple myeloma, recurrent multiple myeloma or a combination thereof.

As used herein, the term, “a” or “an” may mean one or more. As used herein in the claim(s), when used in conjunction with the word “comprising”, the words “a” or “an” may mean one or more than one. As used herein “another” or “other” may mean at least a second or more of the same or different claim element or components thereof.

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

### EXAMPLE 1

### Study Subjects

Bone marrow aspirates were obtained from 92 newly diagnosed multiple myeloma patients who were subsequently treated on National Institutes of Health-sponsored clinical trials. The treatment protocol utilized induction regimens followed by melphalan-based tandem peripheral blood stem cell autotransplants, consolidation chemotherapy, and maintenance treatment (Barlogie et al, 2006). Patients provided samples under Institutional Review Board-approved informed consent and records are kept on file. Multiple myeloma plasma cells (PC) were isolated from heparinized bone marrow aspirates using CD138-based immunomagnetic bead selection using the Miltenyi AUTOMACS™ device (Miltenyi, Bergisch Gladbach, Germany) as previously described (Zhan et al, 2002).

### EXAMPLE 2

### DNA Isolation and Array Comparative Genomic Hybridization

High molecular weight genomic DNA was isolated from aliquots of CD138-enriched plasma cells using the QIAMP® DNA Mini Kit (Qiagen Sciences, Germantown, Md.). Tumor and gender-matched reference genomic DNA (Promega, Madison, Wis.) was hybridized to Agilent 244K arrays using the manufacturer's instructions (Agilent, Santa Clara, Calif.).

### EXAMPLE 3

### Interphase Fluorescence In Situ Hybridization

Copy number changes in multiple myeloma plasma cells were detected using triple color interphase fluorescent in situ hybridization (FISH) analyses of chromosome loci as described (Shaughnessy et al, 2000). Bacterial artificial chromosomes (BAC) clones specific for 13q14 (D13S31), 1q21 (CKS1B), 1p13 (AHCYL1) and 11q13 (CCND1) were obtained from BACPAC Resources Center (Oakland, Calif.) and labeled with Spectrum Red- or Spectrum Green-conjugated nucleotides via nick translation (Vysis, Downers Grove, Ill.).

### EXAMPLE 4

### RNA Purification and Microarray Hybridization

RNA purification, cDNA synthesis, cRNA preparation, and hybridization to the Human Genome U95AV2 and U133PLUS2.0 GENECHIP® microarrays (Affymetrix, Santa Clara, Calif.) were performed as previously described (Shaughnessy et al, 2007; Zhan et al, 2006; Zhan et al, 2007).

### EXAMPLE 5

### Data Analysis

Array comparative genomic hybridization (aCGH) data was normalized by a modified Lowess algorithm (Yang et al, 2002). Statistically altered regions were identified using circular binary segmentation (CBS) algorithm (Venkatraman and Olshen, 2007). ‘Atom region (AR)’ was defined by applying Pearson's correlation coefficient between the signals from adjacent probes. Given the fact that genomic instability is a dynamic process we defined the strength of the DNA breakpoints as being related to the proportion of cases within the cohort and the percentage of tumor cells within a given case as having a given breakpoint. The significance of breakpoint was defined as R=1−correlation coefficient. We considered strong breakpoints (high percentage of cases and high percentage of cells within those cases having a breakpoint) to have an R>=0.4. RMA (Irizarry et al, 2003) package in R was used to perform summarization, normalization of Affymetrix GENECHIP® U133PLUS2.0 expression data. Significant association with outcome was determined using log-rank test for survival. Hazard ratio was calculated using the Cox proportional model. A multivariate survival analysis was applied for selecting independent features that are most significantly associated with outcome. All statistical analyses were performed using the statistics software R (Version 2.6.2), which is free available from http://www.r-project.org, and R packages developed by BioConductor project, which is free available from http://www.bioconductor.org. A detailed description of methods of data analysis are presented in Examples 6-13. We also utilized two additional public gene expression microarray datasets to further validate our findings. The two datasets represent 340 newly diagnosed multiple myeloma patients enrolled in Total Therapy 2 and 206 newly diagnosed multiple myeloma patients in Total Therapy 3 trial, respectively (Shaughnessy et al, 2007). The datasets can be downloaded from NIH GEO using accession number GSE2658. The array comparative genomic hybridization data and gene expression data generated on the 92 cases described here can be downloaded from the Donna D. and Donald M. Lambert Laboratory of Myeloma Genetics website at http://myeloma.uams.edu/lambertlab/software.asp, ftp://ftp.mirt.uams.edu/download/data/aCGH.

### EXAMPLE 6

### Within-Array Normalization

The purpose of within-array normalization is to eliminate systematic bias introduced by inherent properties of the use of different fluorophores and different concentrations of DNA samples in two-channel microarray platform. We applied the Loess algorithm to normalize raw array comparative genomic hybridization data (Pinkel and Albertson, 2005a), which will calculate an estimated log-ratio of the Cy5 channel to the Cy3 channel. The log-ratio indicates the extent of different DNA concentrations between test and reference DNAs. Although according to our experience, the Loess normalization method is robust in most cases, we did find substantial biased signals after Loess normalization. This might be due to the fact that there are too many genomic alterations in myeloma plasma cells and that the alterations are significantly asymmetric (much more DNA gains than DNA losses). So we introduced a heuristic process to account for this issue after obtaining the Loess normalized signals.

We next characterized each chromosome with two features, median and median absolute deviation (MAD) of signals within. We used median and median absolute deviation instead of mean and variance to increase robustness. Median absolute deviation is defined as MAD(S)=median (|sᵢ−median(s)|), where sᵢ represents the signal of probe i.

Second, we excluded chromosomes 3, 5, 7, 9, 11, which typically exhibit whole chromosome gains and the two sex chromosomes. We then applied K-means clustering using those two features to classify all other chromosomes into four subgroups: gain, loss, normal and outlier. Since most chromosomes for K-means should not exhibit gains or losses, the groups with the biggest size would be regarded as normal chromosomes.

Third, the median and median absolute deviation of all signals in normal chromosomes was calculated. After subtracting the median from all signals on an array, we then obtain within-array normalized signals.

### EXAMPLE 7

### Between-Array Normalization

We frequently observed substantial scale differences between microarrays. The differences may come from changes in the photomultiplier tube settings of the scanner or for other reasons not determined (Pinkel and Albertson, 2005a). With this in mind it is necessary to normalize signals between arrays. We therefore transformed the data to guarantee that every array is on the same scale. The calculation used was:

sᵢ_{_{—}}_{scaled}=(sᵢ−median(s))/MAD(s)

where sᵢ represents the within-array normalized signal of probe i.

### EXAMPLE 8

### Segmentation

Segmentation served two purposes: identifying breakpoints and denoising the signal by averaging those within a constant region. We applied a circular binary segmentation (CBS) algorithm developed by Olshen and Venkatraman (Pinkel and Albertson, 2005b), to segment whole chromosomes into contiguous segments such that all DNA within a single segment had the same content. In brief, the algorithm cut a given DNA segment (whole chromosome in the first step) into two or three sub-segments (algorithm automatically decides two or three) and checks whether a middle segment exists that has a different mean value from that of the two flanking segments. If true, the cut points that maximize the difference were determined and the procedure was applied recursively to identify all breakpoints.

### EXAMPLE 9

### Atom Regions

An ‘atom region’ (AR) is a contiguous stretch of DNA flanked by genomic breakpoints in plasma cells from all myeloma cases. The following is the procedure used for defining ARs: We calculated the Pearson's correlation coefficient (cc) of a probe and its neighboring probes and set the correlation coefficient of first point of each chromosome as 0. (For robustness, the top and bottom 1% were excluded from the cc calculation.) Set points with correlation coefficient smaller than a given cut-off were determined to be “0 point” or if greater than the cut-off, “1 point”. All “0 points” and the following no-gap “1 points” were merged into an atom region.

The concept of atom region has both technical and biological advantages. A technical advantage is it reduces dimensionality, from 244 k probes to ˜40 k or fewer atom regions, to facilitate analyses. Atom regions are different from minimal common regions in that they are defined at the level of the individual, while an atom region is defined at the population level. As such it is more appropriate for use in studying properties within populations, e.g. the distribution of copy number changes of a region in samples and its correlation with other regions. Atom region also helps to more precisely define the recurrent breakpoints. It is common in array comparative genomic hybridization data that signals from two different probes can overlap. Due to this noise, breakpoints are often hard to precisely define. The current method determines which atom region the probe belongs to by simultaneously considering signals of adjacent probes in the whole population, thus dramatically boosting the ability to precisely identify joint probes with high confidence. From a biological perspective the atom region might be a natural structural element of chromosome. Understanding atom regions in multiple myeloma and other cancers may help understand why many breakpoints in cancer cells appear to be so consistent, are atom regions in cancer similar to haplotype blocks in the germline; the concept of fragile sites; and the mechanism of genome instability, and evolution of genome instability.

### EXAMPLE 10

### Multivariate Survival Analysis

Cox proportional hazards regression model was used to fit model to data. The procedure is as follow: Step 1. All one-variable models were fitted. The one variable with the highest significance (smallest P value) was selected if the P value of its coefficient was <0.25. Step 2. A stepwise program search through the remaining independent variables for the best N-variable model was achieved by adding each variable one by one into the previous (N−1)-variable model. The variable with highest adjusted significance was selected if the adjusted P value of its coefficient was <0.25. Step 3. We then went back and checked all variables in the model. If any variable had an adjusted P value>0.1, the variable was removed. Step 4. We repeated steps 2 and 3 until no more variables could be added.

### EXAMPLE 11

### Correlation Analysis of Gene Expression Level and DNA Copy Number

For each gene, the Pearson's correlation coefficient between its expression levels and DNA copy numbers of its corresponding genome locus was calculated.

To determine the level of significance of the correlations, the sample labels of 92 patients were randomly shuffled, and then a new correlation coefficient was calculated for each gene. Repeating the shuffling 1000 times, 1000 different correlation coefficients were acquired for each gene, and then the level of significance was determined at the 95^{th} percentile of the 1000 random correlation coefficients.

### EXAMPLE 12

### Sequence Analysis

All analyses were based on human genome sequence National Center for Biotechnology Information (NCBI) build 35 (hg17). The positions of human microRNAs were taken from miRBase (http://microrna.sanger.ac.uk/sequences/). The positions of fragile sites were taken from NCBI gene database (http://www.ncbi.nlm.nih.gov/sites/entrez). The positions of segmental duplications, centromeres and telomeres were taken from University of California at Santa Cruz (UCSC) genome browser. The web tool, LiftOver (http://genome.ucsc.edu/cgi-bin/hgLiftOver), was used to convert genome coordinates from other assemblies (e.g. hg18) to hg17 when necessary.

### EXAMPLE 13

### Gene Ontology (GO) Analysis

Gene ontology classifies genes into different categories according to their attributes, such as functions, procedures involved and locations within cells. The categories are described using a controlled vocabulary. Gene ontology annotations for human genes were downloaded from NCBI gene database (ftp://ftp.ncbi.nih.gov/gene/DATA). The extent of associations of gene sets and gene ontology terms were calculated using Fisher's Exact test.

### EXAMPLE 14

### Pre-Processing of Array Comparative Genomic Hybridization (aCGH) Data and Fluorescent In Situ Hybridization (FISH) Validation

While oligonucleotide-based array comparative genomic hybridization offers a high resolution, it often suffers from high noise (Ylstra et al, 2006). Inappropriate means to adjust for noise in array comparative genomic hybridization raw data often leads to incorrect overall results. To increase signal-to-noise ratios, we applied a pre-processing procedure including supervised normalization and automatic segmentation algorithms. A Lowess normalization method (Yang et al, 2002) was first used to normalize the two-color intensities and to calculate log-ratio signal of the multiple myeloma cell DNA signal and normal reference DNA signal within each array. Since so many DNA regions are amplified in so many multiple myeloma samples, Lowess often under-estimated the overall signals. We therefore introduced a second step of supervised normalization to overcome this issue. In this step, a K-means clustering was applied to identify the normal chromosomal regions with minimal alterations. The signals in these “normal” regions were scaled to a distribution with 0 mean and 1 variance (see Example 6 for details). After normalization and before moving forward, we performed fluorescent in situ hybridization experiments to validate the pre-processed array comparative genomic hybridization signals, which were fundamental for all the subsequent analysis and inferences. We selected 50 cases to investigate three chromosomal regions, 1q21, 11q13 and 13q14, which frequently undergo copy number changes in multiple myeloma. By comparing the pre-process array comparative genomic hybridization signal to fluorescent in situ hybridization results, we confirmed that the array comparative genomic hybridization signal is consistent with fluorescent in situ hybridization results with correlation coefficient 0.76±0.08. Finally, we applied a circular binary segmentation (CBS) algorithm (Venkatraman and Olshen, 2007) to segment whole chromosomes into contiguous segments such that all DNA probes within a single segment have the same signal. The segmentation step further reduced the noise in the signals by averaging signals within a constant region.

### EXAMPLE 15

### Defining Atom Regions (ARs)

The pre-processed signals contains redundant information and the exact break point between two continuous segments is hard to precisely defined due to frequent overlap in the distribution of signals in the two segments. With this in mind, we introduced a concept of ‘atom region’ (AR) in chromosomes. An atom region is a contiguous region of DNA that is always lost or gained together in the tumor samples. We applied a simple Pearson's correlation-based method to identify atom regions (see Example 9). In brief, for any two continuous array comparative genomic hybridization probes, if the correlation coefficient of their pre-processed signals across samples is greater than a given cutoff value (we used a strict cutoff of 0.99), the two will be grouped together into an atom region. This method defined 18,506 atom regions across the entire multiple myeloma genome. Of note, the atom regions defined here were solely based on statistical analysis. Many of them might come from noise in the data instead of a true break point in terms of biology. Although so, we preferred to performing the following analysis based on these atom regions since they contained the most complete information and are flexible whenever a less strict cutoff required.

### EXAMPLE 16

### Overview of Genome Instability in Multiple Myeloma

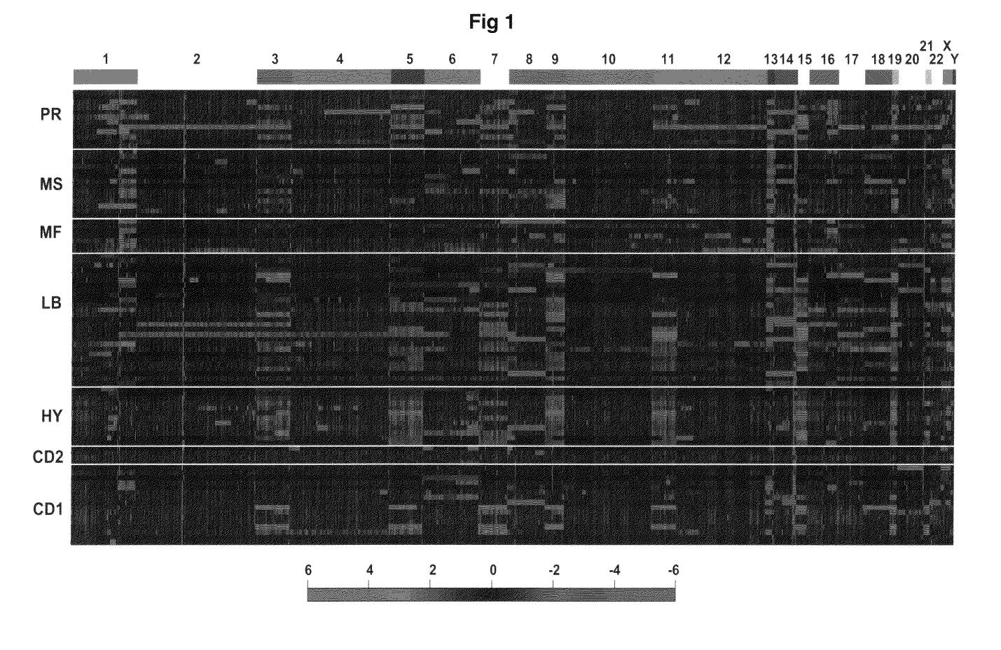

We first evaluated the overall copy number abnormalities in multiple myeloma cells from 92 patients (FIG. 1). The results were largely consistent with the current knowledge of copy number abnormalities in multiple myeloma, such as the presence of gains of chromosome 1q, whole gains of chromosomes 3, 5, 7, 9, 11, 15, 17, 19 and 21, and deletions of chromosome 1p and whole losses of chromosome 13 (Mohamed et al, 2007; Chen et al, 2007). We found that abnormalities in 1p exist as gains/amplifications of the distal region and loss/deletion of the proximal region. The finding is an important correction of the current notion that 1p is primarily affected by deletions and is supported by our recent gene expression profiling-risk model showing loss of expression of genes in the proximal region but increased expression of genes in the telemetric region of 1p in a 70 gene model of high risk disease (Shaughnessy et al, 2007). We also identified less appreciated events such as gains of 6p and losses of 6q, and loss of chromosome 8 and 14 in a substantial number of cases. These have been rarely reported by conventional techniques but were identified in our previous array comparative genomic hybridization studies (Carrasco et al, 2006). We also observed significant DNA gains and losses of chromosomes X and consistent with a recent karyotypic findings in 120 multiple myeloma cases (Mohamed et al, 2007). Such gains and losses of sex chromosomes have now also been linked to patient outcome (see below). A few patient samples exhibited significant abnormalities in chromosomes 2, 4 8, 12, 16, 18 and 20.

Using global gene expression profiling, we have previously shown that multiple myeloma can be divided into seven distinct molecular classes of disease (Zhan et al, 2006; Bergsagel et al, 2001). Four of the classes are associated with known recurrent IGH-mediated translocations. The t(4; 14), activating FGFR3 and MMSET/WHSC1, make up the MS subtype. The t(11; 14) and t(6; 14) activating CCND1 or CCND3 genes, respectively, make up the CD-1 subtype or CD-2 subtype when also expressing CD20. The t(14; 16) and t(14; 20) activating MAF or MAFB, respectively, make up the MF subtype. A group associated with elevated expression of genes mapping to chromosomes 3, 5, 7, 9, 11, 15, and 19 and lacking translocation spikes makes up the hyperdiploid (HY) subtype. A novel disease class with low bone disease with no recognizable genomic features and a unique gene expression signature makes up the low bone disease (LB) subtype. Elevated proliferation genes comprised of cases from each of the other subtypes was also identified and called the PR subtype (Zhan et al, 2006; Begsagel et al, 2001). Evaluation of copy number abnormalities across the seven validated molecular classes revealed expected and unexpected findings (refer to FIG. 1). As expected, hyperdiploid (HY) type myeloma was associated with gains of chromosomes 3, 5, 7, 9, 11, 15, 17, 19 and 21. Interestingly, an unexpected and novel finding here was a subset of cases in virtually all other disease subtypes, including the IGH translocation-related groups (MS, MF, and CD-1), typically thought to be of a non-hyperdiploid nature (Fonseca et al, 2003), had hyperdiploid features. The enigmatic and poorly classified LB subtype was also clearly associated with hyperdiploid features. The CD-2 subtype of disease characterized was practically void of ploidy changes and may explain the good prognosis typically associated with this disease subtype.

### EXAMPLE 17

### Relationship Between Copy Number Abnormalities (CNAs) and Clinical Outcome

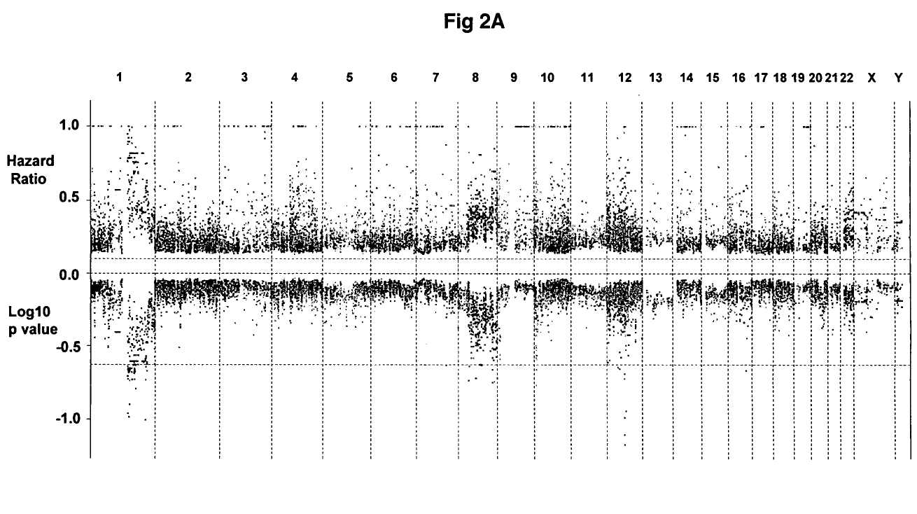

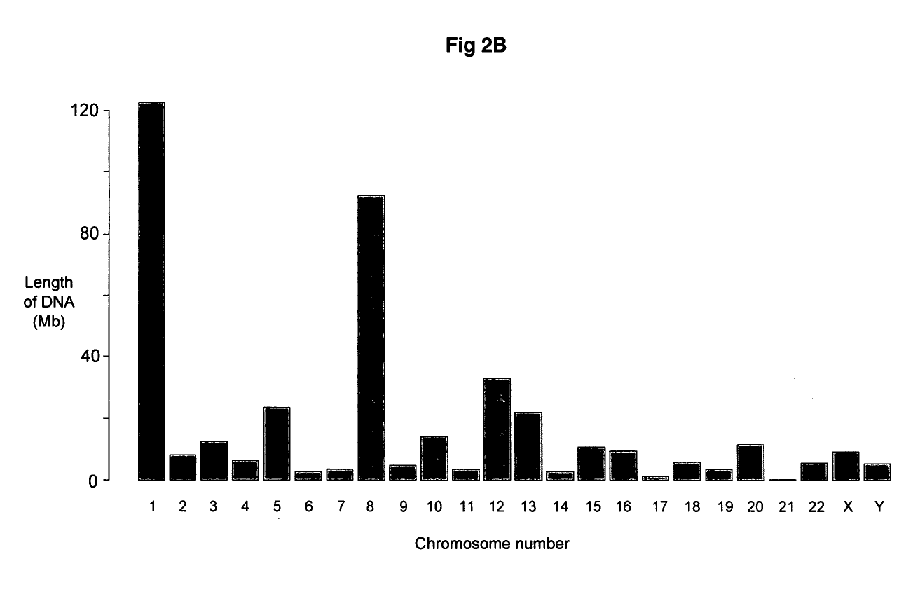

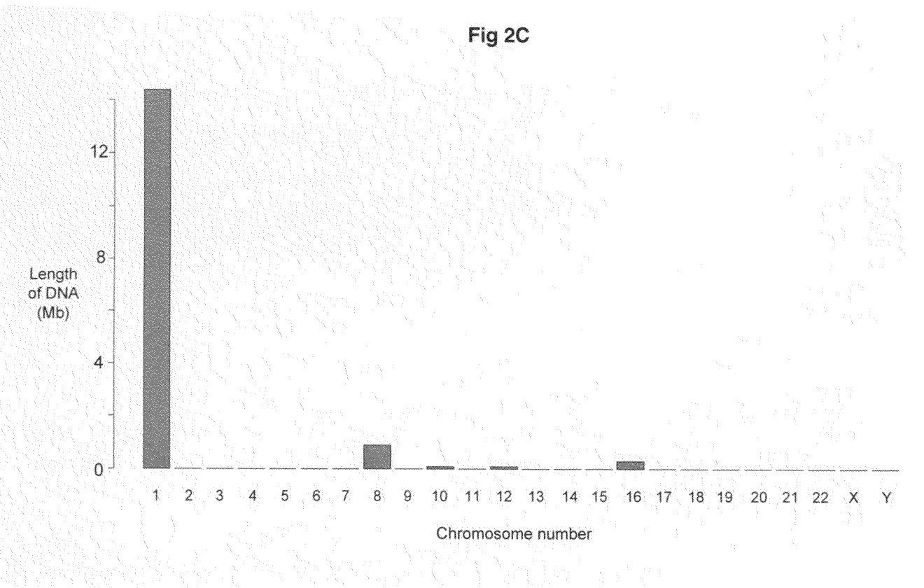

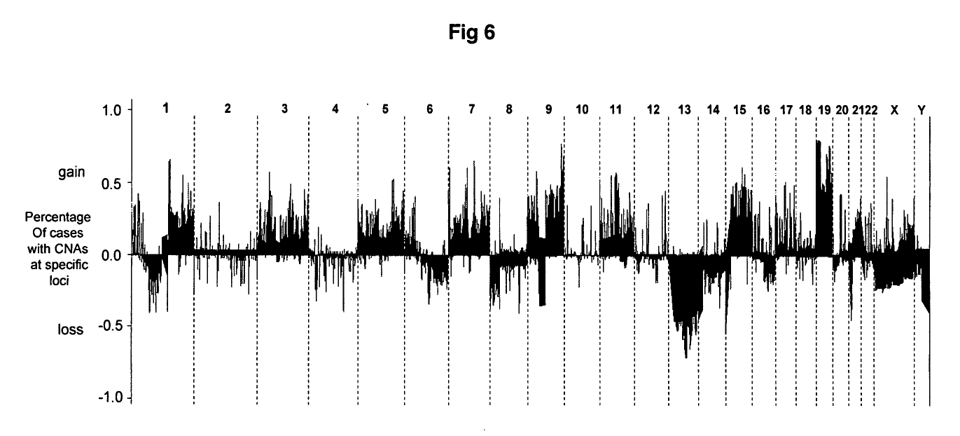

To identify disease-related copy number abnormalities, or so-called driver copy number abnormalities, we integrated array comparative genomic hybidization data and clinical information and applied survival analysis to every atom region. There were a total of 2,929 atom regions involving a ˜416 Mb DNA sequence that was significantly associated with outcome P<0.01 (FIG. 2A). Although clinically relevant copy number abnormalities exist on every chromosome, their distribution across chromosomes was not uniform. The highest correlation with outcome was seen for copy number abnormalities on chromosome 1, exhibiting a liberal statistical significance level of P<0.01 (FIG. 2B) or a more conservative Bonferroni-corrected statistical significance level of P<5.4×10-7 (FIG. 2C). Copy number abnormalities on 1q were more significantly associated with multiple myeloma outcome than copy number abnormalities on 1p and, furthermore, amplification of 1q was the strongest among 1q copy number abnormalities in terms of outcome association. While no more abundant than on other chromosomes, copy number abnormalities on chromosome 8 were the second most significantly associated with outcome (refer to FIG. 1 and FIG. 6).

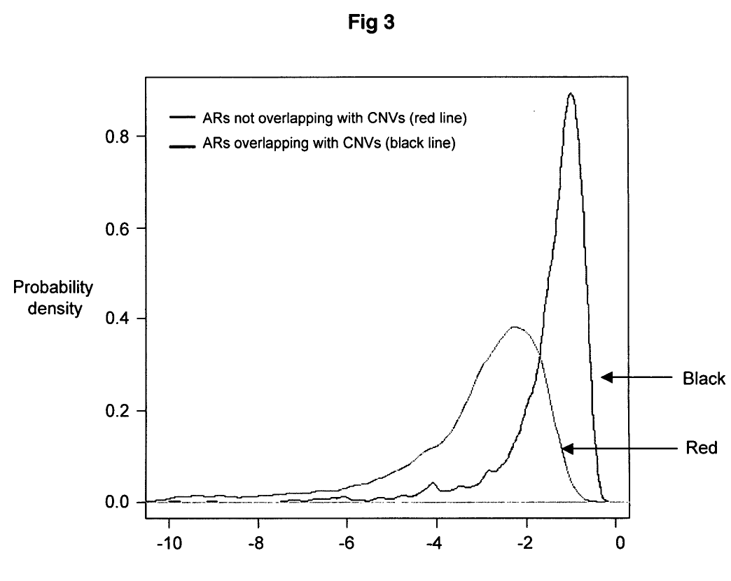

Clinically seemingly irrelevant copy number abnormalities regions may be considered passenger mutations reflecting a general genomic instability in multiple myeloma or corresponding to benign copy number variations (CNVs) within the human population (Zhang et al, 2006). The term “copy number variation” was used here to distinguish copy number alteration defined within the general human population from copy number abnormalities detected in multiple myeloma patients. Ideally, germline genomic DNA corresponding to each tumor sample would be used as the reference DNA. In lieu of such, we compared the multiple myeloma-defined atom regions to known copy number variations in the normal human population (Zhang et al, 2006). Results revealed that 7443 multiple myeloma atom regions have corresponding copy number variations in the normal population. We then compared the multiple myeloma atom regions overlapping (CNV-ARs) to those not overlapping with normal copy number variations (non-CNV-ARs), among which the latter were more likely to be associated with outcome (p=0.012, one-side Kolmogorov-Smimov test) (FIG. 3).

We next investigated whether the size of copy number abnormalities resulting in gains and losses was associated with prognosis. According to class designations associated with poor outcome (class 1, increased copy number; class 2, loss of copy number), the ratios of DNA length in class 1 and class 2 copy number abnormalities were 206 Mb:171 Mb, 101 Mb:31 Mb and 5 Mb:0 Mb, respectively, when applying different significance levels of 0.01, 0.001 and 5.4E-07. These results indicate that class 1 copy number abnormalities were larger than class 2 copy number abnormalities, generally suggesting that increases in copy number appear to be more relevant to poor outcome than loss of DNA.

### EXAMPLE 18

### Relationship Between Copy Number Abnormalities and a Gene Expression-Derived Proliferation Index and High-Risk Index

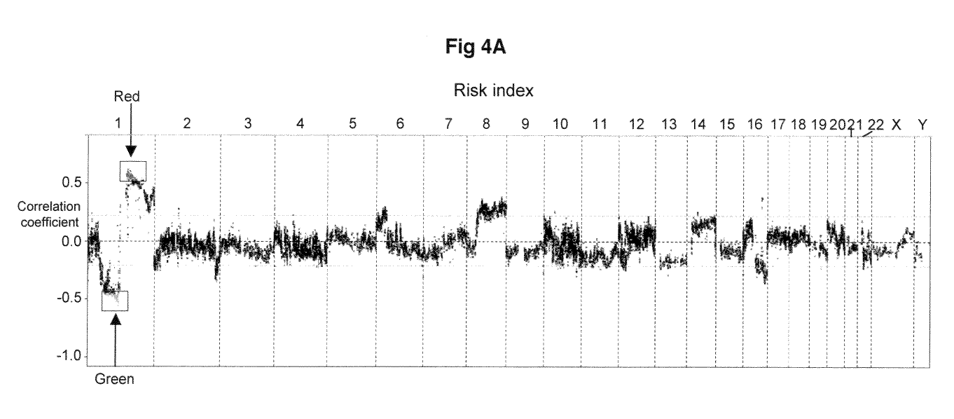

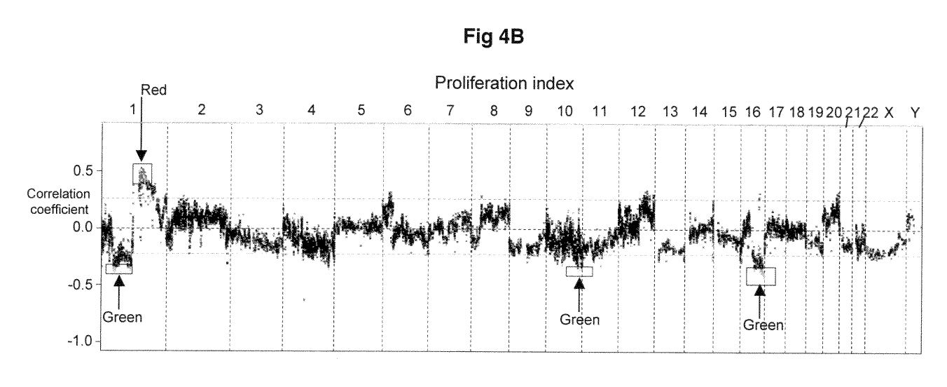

Clinical outcomes could be distinguished on the basis of gene expression profiling-derived proliferation index and risk index values. When examined in the context of copy number abnormalities, loss of 1p and gains of 1q were most significantly correlated with both high proliferation index and high-risk index. Thus, the top 100 copy number abnormalities positively and negatively correlated with the risk index were located in 1p and lq (FIG. 4A). Similarly, the 100 copy number abnormalities most positively correlated with the proliferation index were located on 1q while 52 of the top 100 copy number abnormalities negatively correlated with proliferation index were located on 1p (FIG. 4B). Interestingly we found that while not strongly related to the proliferation index, gains of 8q24 were strongly related to the risk index. Taken together, these data strongly suggest that gains of 1q and losses of 1p genomic DNA cause changes in the expression of resident genes, which are associated with, or actually are at the root of, an aggressive clinical course in multiple myeloma. These data therefore seem to prove that a recent gene expression model of high-risk disease characterized by increased expression of genes mapping to lq and 8q and reduced expression of genes mapping to 1p is strongly related to copy number abnormalities at these loci. Interestingly, while strongly linked to high-risk, gains of 8q24 proved to be unrelated to multiple myeloma-cell proliferation, suggesting that gains of 8q24 are a unique feature of high-risk disease. This is important because we also previously showed that while the gene expression-based high risk signature and the proliferation index were correlated, cases with high-risk and low proliferation did as poorly as those with high-risk and high proliferation and, importantly, those with low-risk and high proliferation did as well as those with low-risk and low proliferation. Thus high-risk defined through this analysis is unique from the defined high proliferation and therefore high-risk must arise from unique biological events not linked to cell proliferation. These data would imply that copy number abnormalities at 8q24 might be this critical distinguishing feature and that a more comprehensive investigation into the role of 8q24 gains in disease progression is warranted.

### EXAMPLE 19

### Relationship between CNA Breakpoints and Chromosome-Structural Features

We next evaluated the relationship between the position of copy number abnormality breakpoints and known chromosome-structural features such as segmental duplications, centromeres, and telomeres. The results revealed that copy number abnormality breakpoints were most significantly associated with segmental duplications and centromeres (Table 1). In contrast to “weak breakpoints”, those seen in a high percentage of cases and, within cases, in a high percentage of tumor cells (“strong breakpoints”), were not found in telomeric regions. We take these data to suggest that breakpoints near telomeres tend to not confer a selective proliferative advantage. We further investigated the correlation between known fragile sites, another potential link to chromosome instability, and copy number abnormality breakpoints. Since most fragile sites are not precisely mapped in the genome, we compared the distribution of copy number abnormality breakpoints in every chromosome cytoband. The results of application of the Kolmogorov-Smirnov test strongly suggested that fragile sites and copy number abnormality breakpoints in multiple myeloma are not associated (Table 1).

TABLE 1
Breakpoint enrichment in genomic structures.

| | segment | | | | fragile |
|---|---|---|---|---|---|
| cutoff | duplications** | centromeres** | telomeres** | genes*** | sites**** |
| 1 (N* = 223454; control) | 5865 | 1143 | 16743 | 136665 | NA |
| 0.95 (N = 3734) | 404 (p < 1e−16) | 51 (p = 6e−10) | 366 (p = 1e−7) | 1931 (p < 1e−16) | p < 2.2e−16 |
| 0.8 (N = 623) | 146 (p < 1e−16) | 21 (p = 2e−11) | 78 (p = 7e−7) | 295 (p = 1e−12) | p < 2.2e−16 |
| 0.6 (N = 153) | 56 (p < 1e−16) | 7 (p = 2e−5) | 14 (p = 0.26) | 1 83 (p = 0.03) | p < 2.2e−16 |
| 0.4 (N = 59) | 18 (p = 8e−15) | 3 (p = 0.004) | 3 (p = 0.8) | 30 (p = 0.04) | p < 2.2e−16 |

*number of break points;
**Null hypothesis: the number of observed break points is not greater than expected; Fisher's Exact test.;
***Null hypothesis: the number of observed break points is not less than expected; Fisher's Exact test.;
****Null hypothesis: the distribution of breaks points in cytobands is same as that of fragile sites in cytobands; Kolmogorov-Smirnov test.

### EXAMPLE 20

### Defining Recurrent Copy Number Abnormality Breakpoints within Genes

Although the majority of copy number abnormality breakpoints were found in intergenic regions (Table 1), strong breakpoints (those found in a significant number of cases and within a significant number of cells within a case) within genes were identified and might point to important disease-related genes. A list of recurrent breakpoints and corresponding genes in which strong breakpoints were identified is provided (Table 2). Given that plasma cells are late stage B-cells that have undergone chromosomal rearrangements in both heavy and light chain immunoglobulin genes, it is noteworthy that our method of identifying gene centric breakpoints revealed hits in the IGH, IGK and IGL loci (Table 2). The ability to identify expected breakpoints in the immunoglobulin loci provides strong evidence that recurrent breakpoints in genes outside the immunoglobulin loci may point to important candidate disease genes. Actual determination of their relevance will require further studies.

TABLE 2
Genes at recurrent DNA breakpoints.

| Break point | chrom | Start | End | Relationship* | Gene |
|---|---|---|---|---|---|
| break4 | 1 | 7668065 | 7677663 | belong_to | CAMTA1 |
| break5 | 1 | 7688736 | 7696087 | belong_to | CAMTA1 |
| break8 | 1 | 23630447 | 23631229 | belong_to | ID3 |
| break9 | 1 | 23631514 | 23637594 | 5′_overlap_with_3′ | ID3 |
| break10 | 1 | 25330634 | 25354765 | 3′_overlap_with_5′ | RHCE |
| break10 | 1 | 25330634 | 25354765 | 3′_overlap_with_5′ | RHD |
| break11 | 1 | 25408815 | 25414726 | 3′_overlap_with_5′ | TMEM50A |
| break15 | 1 | 109933787 | 109944351 | 3′_overlap_with_5′ | GSTM1 |
| break16 | 1 | 109951947 | 109968401 | 3′_overlap_with_5′ | GSTM5 |
| break17 | 1 | 116880909 | 116887268 | belong_to | IGSF3 |
| break18 | 1 | 116906096 | 116911994 | belong_to | IGSF3 |
| break19 | 1 | 149362629 | 149369522 | contain | LCE3D |
| break20 | 1 | 149394958 | 149403519 | contain | LCE3B |
| break21 | 1 | 149572677 | 149573806 | belong_to | LCE1E |
| break22 | 1 | 149582884 | 149586912 | contain | LCE1D |
| break23 | 1 | 165948301 | 165958802 | belong_to | NME7 |
| break24 | 1 | 165972916 | 165988174 | belong_to | NME7 |
| break25 | 1 | 193443252 | 193470554 | 5′_overlap_with_3′ | CFH |
| break28 | 2 | 88968794 | 89003124 | 3′—overlap—with—5′ | IGK@ |
| break28 | 2 | 88968794 | 89003124 | 3′—overlap—with—5′ | IGKC |
| break28 | 2 | 88968794 | 89003124 | 3′—overlap—with—5′ | IGKV1-5 |
| break28 | 2 | 88968794 | 89003124 | 3′—overlap—with—5′ | IGKV2-24 |
| break29 | 2 | 89159181 | 89162648 | beloag—to | IGK@ |
| break29 | 2 | 89159181 | 89162648 | belong—to | IGKC |
| break29 | 2 | 89159181 | 89162648 | belong—to | IGKV1-5 |
| break29 | 2 | 89159181 | 89162648 | belong—to | IGKV2-24 |
| break33 | 2 | 233066421 | 233071655 | 3′_overlap_with_5′ | ALPP |
| break34 | 2 | 233077112 | 233087160 | 5′_overlap_with_3′ | ECEL1P2 |
| break37 | 3 | 42706908 | 42710164 | 3′_overlap_with_5′ | HHATL |
| break37 | 3 | 42706908 | 42710164 | 5′_overlap_with_3′ | KBTBD5 |
| break38 | 3 | 48589507 | 48596204 | belong_to | COL7A1 |
| break39 | 3 | 48600544 | 48605606 | belong_to | COL7A1 |
| break41 | 3 | 127130406 | 127138046 | 3′_overlap_with_5′ | LOC200810 |
| break45 | 4 | 9047040 | 9052805 | 5′_overlap_with_3′ | DUB4 |
| break48 | 4 | 42245850 | 42255684 | 3′_overlap_with_5′ | ATP8A1 |
| break49 | 4 | 56972990 | 56989186 | belong_to | KIAA1211 |
| break50 | 4 | 69051841 | 69203906 | contain | TMPRSS11E |
| break51 | 4 | 69311985 | 69789443 | contain | TMPRSS11E |
| break51 | 4 | 69311985 | 69789443 | contain | UGT2B15 |
| break54 | 4 | 114351279 | 114358021 | belong_to | ANK2 |
| break58 | 4 | 184980243 | 184981102 | belong_to | FLJ12716 |
| break62 | 5 | 140196482 | 140203440 | belong_to | PCDHA1 |
| break62 | 5 | 140196482 | 140203440 | belong_to | PCDHA2 |
| break62 | 5 | 140196482 | 140203440 | belong_to | PCDHA3 |
| break62 | 5 | 140196482 | 140203440 | belong_to | PCDHA4 |
| break62 | 5 | 140196482 | 140203440 | belong_to | PCDHA5 |
| break62 | 5 | 140196482 | 140203440 | belong_to | PCDHA6 |
| break62 | 5 | 140196482 | 140203440 | 5′_overlap_with_3′ | PCDHA7 |
| break62 | 5 | 140196482 | 140203440 | belong_to | PCDHA7 |
| break62 | 5 | 140196482 | 140203440 | 3′_overlap_with_5′ | PCDHA8 |
| break66 | 6 | 32519935 | 32558677 | 5′_overlap_with_3′ | HLA-DRA |
| break67 | 6 | 32738443 | 32745036 | 5′_overlap_with_3′ | HLA-DQB1 |
| break70 | 6 | 165690639 | 165695958 | 5′_overlap_with_3′ | C6orf118 |
| break74 | 7 | 97190472 | 97212927 | contain | LOC441268 |
| break79 | 7 | 141958920 | 141965869 | belong_to | TRBV5-4 |
| break80 | 7 | 141978333 | 141984935 | belong_to | TRBV5-4 |
| break81 | 7 | 143391065 | 143512140 | 3′_overlap_with_5′ | ARHGEF5 |
| break81 | 7 | 143391065 | 143512140 | contain | ARHGEF5 |
| break81 | 7 | 143391065 | 143512140 | contain | CTAGE4 |
| break81 | 7 | 143391065 | 143512140 | contain | OR2A1 |
| break81 | 7 | 143391065 | 143512140 | 5′_overlap_with_3′ | OR2A20P |
| break81 | 7 | 143391065 | 143512140 | contain | OR2A20P |
| break81 | 7 | 143391065 | 143512140 | contain | OR2A7 |
| break81 | 7 | 143391065 | 143512140 | 5′_overlap_with_3′ | OR2A9P |
| break81 | 7 | 143391065 | 143512140 | contain | OR2A9P |
| break82 | 7 | 151508153 | 151516588 | belong_to | MLL3 |
| break83 | 7 | 151525106 | 151531305 | belong_to | MLL3 |
| break84 | 8 | 7789937 | 8117271 | 5′_overlap_with_3′ | DEFB4 |
| break85 | 8 | 39341524 | 39356595 | belong_to | ADAM5P |
| break87 | 8 | 145356550 | 145464363 | 3′_overlap_with_5′ | BOP1 |
| break87 | 8 | 145356550 | 145464363 | contain | C8orf30A |
| break87 | 8 | 145356550 | 145464363 | 5′_overlap_with_3′ | KIAA1833 |
| break87 | 8 | 145356550 | 145464363 | contain | KIAA1833 |
| break88 | 8 | 145469632 | 145482428 | belong_to | BOP1 |
| break91 | 10 | 5246837 | 5252988 | 5′_overlap_with_3′ | AKR1C4 |
| break92 | 10 | 5484859 | 5492330 | 5′_overlap_with_3′ | NET1 |
| break93 | 10 | 21353602 | 21360811 | belong_to | NEBL |
| break94 | 10 | 37490629 | 37508402 | belong_to | ANKRD30A |
| break95 | 10 | 37523207 | 37530005 | belong_to | ANKRD30A |
| break96 | 10 | 47970511 | 47976982 | 3′_overlap_with_5′ | ZNF488 |
| break97 | 10 | 48272394 | 48866929 | contain | BMS1P5 |
| break97 | 10 | 48272394 | 48866929 | contain | CTGLF1 |
| break97 | 10 | 48272394 | 48866929 | contain | FRMPD2L1 |
| break97 | 10 | 48272394 | 48866929 | contain | FRMPD2L2 |
| break97 | 10 | 48272394 | 48866929 | contain | PTPN20A |
| break97 | 10 | 48272394 | 48866929 | contain | PTPN20B |
| break98 | 10 | 52862509 | 52875630 | belong_to | PRKG1 |
| break99 | 10 | 52881487 | 52888819 | belong_to | PRKG1 |
| break100 | 10 | 67742738 | 67748408 | belong_to | CTNNA3 |
| break101 | 10 | 67779990 | 67792807 | belong_to | CTNNA3 |
| break102 | 10 | 68881450 | 68892055 | belong_to | CTNNA3 |
| break105 | 10 | 101076508 | 101083687 | 3′_overlap_with_5′ | CNNM1 |
| break109 | 10 | 124143379 | 124152627 | belong_to | PLEKHA1 |
| break110 | 10 | 127563278 | 127578239 | 5′_overlap_with_3′ | DHX32 |
| break110 | 10 | 127563278 | 127578239 | 3′_overlap_with_5′ | FANK1 |
| break111 | 10 | 127584068 | 127591536 | belong_to | FANK1 |
| break113 | 11 | 5762182 | 5766615 | 3′_overlap_with_5′ | OR52N1 |
| break118 | 12 | 11393473 | 11404653 | contain | PRB1 |
| break121 | 12 | 46382812 | 46389788 | 5′_overlap_with_3′ | RPAP3 |
| break126 | 14 | 19497023 | 19515781 | contain | OR4K15 |
| break127 | 14 | 105280523 | 105286479 | belong—to | IGH@ |
| break127 | 14 | 105280523 | 105286479 | belong—to | IGHA1 |
| break127 | 14 | 105280523 | 105286479 | belong—to | IGHG1 |
| break128 | 14 | 105330913 | 105343150 | belong—to | IGH@ |
| break128 | 14 | 105330913 | 105343150 | belong—to | IGHA1 |
| break128 | 14 | 105330913 | 105343150 | belong—to | IGHG1 |
| break129 | 14 | 105630089 | 105643293 | belong—to | IGHA1 |
| break129 | 14 | 105630089 | 105643293 | belong—to | IGHG1 |
| break131 | 15 | 76712542 | 76715921 | belong_to | CHRNB4 |
| break134 | 15 | 82745143 | 82891457 | 3′_overlap_with_5′ | FLJ43276 |
| break134 | 15 | 82745143 | 82891457 | 5′_overlap_with_3′ | KIAA1920 |
| break136 | 16 | 31835555 | 31842335 | 5′_overlap_with_3′ | ZNF267 |
| break137 | 16 | 69397102 | 69409493 | 3′_overlap_with_5′ | HYDIN |
| break138 | 17 | 21042201 | 21047062 | belong_to | TMEM11 |
| break141 | 19 | 18814042 | 18824866 | belong_to | UPF1 |
| break142 | 19 | 40539029 | 40543992 | contain | FFAR3 |
| break143 | 19 | 56816785 | 56831724 | 5′_overlap_with_3′ | SIGLEC5 |
| break145 | 20 | 1506379 | 1516966 | belong_to | SIRPB1 |
| break146 | 20 | 28133609 | 28186969 | 5′_overlap_with_3′ | FLJ45832 |
| break149 | 20 | 32603344 | 32611751 | 3′_overlap_with_5′ | MAP1LC3A |
| break149 | 20 | 32603344 | 32611751 | belong_to | MAP1LC3A |
| break150 | 20 | 32611988 | 32619796 | 3′_overlap_with_5′ | PIGU |
| break151 | 22 | 21563415 | 21570383 | 5′—overlap—with—3′ | IGL@ |
| break151 | 22 | 21563415 | 21570383 | belong—to | IGL@ |
| break151 | 22 | 21563415 | 21570383 | 5′—overlap—with—3′ | IGLJ3 |
| break151 | 22 | 21563415 | 21570383 | 5′—overlap—with—3′ | IGLV3-25 |
| break151 | 22 | 21563415 | 21570383 | belong—to | IGLV3-25 |
| break151 | 22 | 21563415 | 21570383 | belong—to | IGLV4-3 |

We investigated break points with significance>0.4 (correlation coefficient<0.6) for their location within genes. Bold breakpoints and genes indicate immunoglobulin genes on chromosome 2, 14, and 22.

Since we cannot determine the exact position of a break point due to the limited resolution of the array comparative genomic hybridization platform, we use the gap between two adjacent probes, in which a break point was located, to represent the break point. Relationship definitions are as follows: “belongs_to” means a break point-associated region is within a gene; “contain” means a break point-associated region contains an entire gene; “5′_overlaps with 3′” means the 5′ end of a break point-associated region overlaps with the 3′ of a gene; “3′_overlaps with_{—}5′” means the 3′ end of a break point-associated region overlaps with the 5′ of a gene.

### EXAMPLE 21

### CNAs Affecting microRNAs (miRNA)

MicroRNAs (miRNAs) are a novel class of small non-coding RNAs that play important roles in development and differentiation by regulating gene expression through repression of mRNA translation or promoting the degradation of mRNA. Emerging evidence has revealed that deregulated expression of miRNAs is implicated in tumorigenesis. Importantly, for purposes of the current study, recent studies have demonstrated that miRNAs reside in the genome affected by copy number abnormalities (Calin and Croce, 2006; Calin and Croce, 2007).

To investigate copy number abnormalities that might target miRNAs, we first determined the chromosomal distribution of miRNAs across the entire human genome. It is interesting to note that more miRNAs are located on odd chromosomes (N=268), which typically exhibit trisomies in hyperdiploid multiple myeloma, than on even chromosomes (N=179) (Table 3). We next investigated whether miRNAs are enriched in regions exhibiting copy number abnormalities in multiple myeloma (Table 4). These data revealed that miRNAs are indeed enriched in copy number abnormalities exhibiting gains and losses but that miRNAs were also enriched in copy number abnormalities significantly associated with outcome (Table 5). These data suggests that miRNAs might be targets of copy number abnormalities in multiple myeloma.

TABLE 3
Chromosomal distribution of micro RNA (miRNA)
across the human genome

| | No of |
|---|---|
| chr | miRNA |
| chr18 | 5 |
| chr21 | 5 |
| chr16 | 9 |
| chr22 | 10 |
| chr6 | 10 |
| chr13 | 11 |
| chr2 | 12 |
| chr10 | 13 |
| chr15 | 13 |
| chr20 | 14 |
| chr4 | 15 |
| chr11 | 18 |
| chr5 | 18 |
| chr8 | 18 |
| chr12 | 19 |
| chr3 | 23 |
| chr9 | 24 |
| chr7 | 25 |
| chr17 | 29 |
| chr1 | 33 |
| chr14 | 54 |
| chrX | 62 |
| chr19 | 69 |

TABLE 4
Enrichment of genes and micro RNAs in recurrent copy number abnormalities.

| | Cutoff of recurrence | | | | | |
|---|---|---|---|---|---|---|
| | 5 | | 40 | | 60 | |
| | Length of ARs | #miRNA | Length of ARs | #miRNA | Length of ARs | #miRNA |
| Recurrent ARs | 2327311122 | 493 | 380571188 | 151 | 65918127 | 28 |
| All ARs | 2606524268 | 509 | 2606524268 | 509 | 2606524268 | 509 |
| P* | | 0.03491876 | | 2.00E−15 | | 7.58E−05 |

*Null hypothesis: the number of miRNAs in recurrent atom regions (ARs) is not greater than that in all ARs; Proportional test.

TABLE 5
Enrichment of genes and micro RNAs (miRNAs) in outcome-associated regions.

| | Cutoff of association with outcome | | | | | |
|---|---|---|---|---|---|---|
| | 0.01 | | 0.001 | | 5.40E−07 | |
| | Length of ARs | #miRNA | Length of ARs | #miRNA | Length of ARs | #miRNA |
| Outcome-associated ARs | 416147848 | 66 | 202014911 | 43 | 15754559 | 3 |
| All | 2606524268 | 509 | 2606524268 | 509 | 2606524268 | 509 |
| P* | | 0.95 | | 0.25 | | 0.37 |

*Null hypothesis: the number of miRNAs in outcome-associated atom regions (ARs) is not greater than that in all ARs; Proportional test.

### EXAMPLE 22

### Identification of Candidate Disease Genes

By combining copy number abnormalities, gene expression data, and survival information we next investigated disease progression-related regions/genes. A stepwise multivariate survival analysis was performed to identify 14 atom regions from 587 atom regions with an optimal log-rank P-value<0.0001 (Table 6). For each atom region/gene, we selected an optimal cut-off value to separate 92 cases into two groups, performed log-rank tests and employed Cox proportional hazard models to compare differences in survival time of the two groups. The optimal cut-off value was selected by walking along all value points such that we identified the value that gave the smallest P-value in a log-rank test. We knew that while the optimized P-value used here minimized false negatives, the false positives would be greatly enhanced. However, this tradeoff was deemed acceptable since false positives would be filtered when copy number abnormalities data was integrated with the gene expression results. Potential candidate genes were defined by the following criteria: 1) gene expression had to be associated with outcome (P<0.01); 2) the copy number of its locus had to be associated with outcome (P<0.01); and 3) the correlation co-efficient of the gene expression and the copy number of its genomic locus had to be greater than 0.3, which was determined by a re-sampling procedure on sample labels (see Examples 5-13). Using these criteria we discovered a list of 210 genes (Table 7). According to Gene Ontology analysis these genes are enriched in those whose protein products are involved in rRNA processing, RNA splicing, epidermal growth factor receptor signaling pathway, the ubiquitin-dependent proteasomal-mediated protein catabolic process, mRNA transport, phospholipid biosynthesis, protein targeting to mitochondria, and cell cycle (P<0.01). Remarkably, 122 of the 210 genes are located on 1q region, providing further support for a central role of 1q21 gains in multiple myeloma pathogenesis. In addition, we found 21 genes located on chromosome 13, and 17 of them located in band 13q14. This analysis identified copy number abnormalities and copy number abnormalities resident copy number sensitive genes related to survival in multiple myeloma that represent candidate disease genes.

TABLE 6
Atom regions (ar) selected by multiple variable analysis. Position is
based National Center for Biotechnology Information Build
35 (hg17) of human genome

| AR | Chromosome | Start | End | Cytoband |
|---|---|---|---|---|
| ar867 | chr1 | 107982464 | 107982464 | 1p13.3 |
| ar898 | chr1 | 111692355 | 112345631 | 1p13.2 |
| ar987 | chr1 | 143522963 | 143586636 | 1q21.1 |
| ar986 | chr1 | 143488396 | 143488396 | 1q21.1 |
| ar1005 | chr1 | 148669922 | 148696302 | 1q21.3 |
| ar1096 | chr1 | 166610113 | 166632293 | 1q24.2 |
| ar10374 | chr10 | 1475617 | 1481986 | 10p15.3 |
| ar10953 | chr10 | 51676176 | 51676176 | 10q11.23 |
| ar12822 | chr12 | 5025918 | 5054899 | 12p13.32 |
| ar4366 | chr3 | 131243292 | 131310594 | 3q21.3 |
| ar8698 | chr7 | 39383320 | 39421848 | 7p14.1 |
| ar8984 | chr7 | 115446592 | 115446592 | 7q31.2 |
| ar9842 | chr8 | 129014332 | 129081332 | 8q24.21 |
| ar9841 | chr8 | 128929438 | 129006840 | 8q24.21 |

TABLE 7
Candidate genes.

| | Gene | | correl | copy number | | | gene expression | | |
|---|---|---|---|---|---|---|---|---|---|
| Entrez_ID | Symbol | Cytoband | coeffic | p | cutoff | HR | p | cutoff | HR |
| 8848 | TSC22D1 | 13q14 | 0.351 | 0.000678 | 0.01105 | 0.16227 | 0.008872 | 92.728 | 0.40388 |
| 10390 | CEPT1 | 1p13.3 | 0.554 | 0.000081 | −2.40583 | 0.17538 | 0.000138 | 117.284 | 0.15940 |
| 79961 | DENND2D | 1p13.3 | 0.304 | 0.000081 | −2.40583 | 0.17538 | 0.000314 | 129.291 | 0.17021 |
| 23155 | CLCC1 | 1p13.3 | 0.366 | 0.000081 | −1.75910 | 0.17538 | 0.000174 | 131.273 | 0.19183 |
| 9860 | LRIG2 | 1p13.1 | 0.467 | 0.000081 | −1.39948 | 0.17538 | 0.003732 | 27.251 | 0.20525 |
| 199857 | ALG14 | 1p21.3 | 0.325 | 0.000081 | −2.49853 | 0.17538 | 0.001505 | 132.298 | 0.23864 |
| 178 | AGL | 1p21 | 0.492 | 0.000081 | −2.32116 | 0.17538 | 0.000373 | 82.170 | 0.25359 |
| 22911 | WDR47 | 1p13.3 | 0.396 | 0.000081 | −1.75910 | 0.17538 | 0.000164 | 75.413 | 0.27025 |
| 25950 | RWDD3 | 1p21.3 | 0.503 | 0.000081 | −3.22944 | 0.17538 | 0.000806 | 91.912 | 0.30095 |
| 2773 | GNAI3 | 1p13 | 0.385 | 0.000081 | −1.75910 | 0.17538 | 0.008288 | 74.612 | 0.31975 |
| 51592 | TRIM33 | 1p13.1 | 0.620 | 0.000081 | −2.24349 | 0.17538 | 0.002672 | 430.354 | 0.35480 |
| 10286 | BCAS2 | 1p21-p13.3 | 0.405 | 0.000081 | −2.24349 | 0.17538 | 0.002645 | 360.175 | 0.36868 |
| 2745 | GLRX | 5q14 | 0.348 | 0.000206 | −0.82178 | 0.21444 | 0.006941 | 1,567.768 | 0.38263 |
| 22936 | ELL2 | 5q15 | 0.365 | 0.000206 | −0.82178 | 0.21444 | 0.005599 | 2,433.440 | 0.39863 |
| 7529 | YWHAB | 20q13.1 | 0.310 | 0.000107 | 0.11976 | 0.21717 | 0.004422 | 974.812 | 0.24197 |
| 63935 | C20orf67 | 20q13.12 | 0.308 | 0.000124 | 0.11976 | 0.21991 | 0.005478 | 154.460 | 0.35365 |
| 10928 | RALBP1 | 18p11.3 | 0.388 | 0.001355 | −0.29455 | 0.22905 | 0.003194 | 279.619 | 0.27541 |
| 23253 | ANKRD12 | 18p11.22 | 0.391 | 0.001355 | −0.29455 | 0.22905 | 0.005934 | 342.678 | 0.39747 |
| 10542 | HBXIP | 1p13.3 | 0.412 | 0.001598 | −2.39340 | 0.23631 | 0.003100 | 367.384 | 0.25296 |
| 10240 | MRPS31 | 13q14.11 | 0.597 | 0.002945 | 0.03280 | 0.25995 | 0.000444 | 247.989 | 0.28799 |
| 11193 | WBP4 | 13q14.11 | 0.575 | 0.002945 | 0.03280 | 0.25995 | 0.000334 | 56.651 | 0.30320 |
| 84078 | KBTBD7 | 13q14.11 | 0.473 | 0.002945 | 0.03280 | 0.25995 | 0.000867 | 39.705 | 0.32176 |
| 89890 | KBTBD6 | 13q14.11 | 0.486 | 0.002945 | 0.03280 | 0.25995 | 0.001037 | 31.448 | 0.32855 |
| 1997 | ELF1 | 13q13 | 0.421 | 0.002945 | 0.03280 | 0.25995 | 0.008040 | 408.266 | 0.37028 |
| 2308 | FOXO1 | 13q14.1 | 0.377 | 0.002945 | 0.03280 | 0.25995 | 0.006606 | 138.849 | 0.40177 |
| 4212 | MEIS2 | 15q14 | 0.421 | 0.007986 | −0.73743 | 0.26476 | 0.007077 | 499.679 | 0.17496 |
| 10904 | BLCAP | 20q11.2-q12 | 0.360 | 0.007962 | −0.64147 | 0.26489 | 0.001009 | 243.707 | 0.24934 |
| 23189 | ANKRD15 | 9p24.3 | 0.477 | 0.009284 | 1.78666 | 0.27379 | 0.002286 | 710.717 | 0.27413 |
| 6760 | SS18 | 18q11.2 | 0.344 | 0.005279 | −0.39011 | 0.27717 | 0.004616 | 95.689 | 0.33356 |
| 55861 | DBNDD2 | 20q13.12 | 0.370 | 0.001541 | 0.11976 | 0.27900 | 0.000174 | 168.894 | 0.20809 |
| 79925 | SPEF2 | 5p13.2 | 0.344 | 0.000919 | −0.27451 | 0.28973 | 0.007463 | 22.870 | 0.25818 |
| 7750 | ZMYM2 | 13q11-q12 | 0.480 | 0.007432 | 0.00500 | 0.31753 | 0.001594 | 187.267 | 0.26547 |
| 9675 | KIAA0406 | 20q11.23 | 0.382 | 0.003835 | 0.11976 | 0.32081 | 0.001875 | 155.203 | 0.24372 |
| 57148 | KIAA1219 | 20q11.23 | 0.386 | 0.003835 | 0.11976 | 0.32081 | 0.008726 | 218.281 | 0.36800 |
| 83548 | COG3 | 13q14.12 | 0.500 | 0.005243 | 0.01265 | 0.32095 | 0.007411 | 122.132 | 0.33695 |
| 29883 | CNOT7 | 8p22-p21.3 | 0.525 | 0.003352 | −0.29683 | 0.32431 | 0.000022 | 793.373 | 0.20659 |
| 54737 | MPHOSPH8 | 13q12.11 | 0.619 | 0.009939 | 0.00500 | 0.32976 | 0.001519 | 190.855 | 0.33981 |
| 6687 | SPG7 | 16q24.3 | 0.408 | 0.001705 | 0.48643 | 0.33421 | 0.003731 | 257.844 | 0.32550 |
| 8658 | TNKS | 8p23.1 | 0.487 | 0.006493 | 0.18246 | 0.34912 | 0.004238 | 57.562 | 0.27261 |
| 51507 | C20orf43 | 20q13.31 | 0.312 | 0.008479 | 0.11837 | 0.35803 | 0.002436 | 418.684 | 0.27413 |
| 29103 | DNAJC15 | 13q14.1 | 0.476 | 0.003687 | −1.23763 | 0.36541 | 0.001104 | 124.142 | 0.28283 |
| 55213 | RCBTB1 | 13q14 | 0.379 | 0.003899 | −1.23763 | 0.36737 | 0.000279 | 232.069 | 0.14864 |
| 83852 | SETDB2 | 13q14 | 0.392 | 0.003899 | −1.23763 | 0.36737 | 0.000059 | 106.694 | 0.26833 |
| 10206 | TRIM13 | 13q14 | 0.478 | 0.003899 | −1.23763 | 0.36737 | 0.002245 | 156.193 | 0.29426 |
| 57213 | C13orf1 | 13q14 | 0.359 | 0.003899 | −1.23763 | 0.36737 | 0.002488 | 58.189 | 0.36443 |
| 22862 | FNDC3A | 13q14.2 | 0.351 | 0.003899 | −1.23763 | 0.36737 | 0.002879 | 1,207.287 | 0.36613 |
| 5108 | PCM1 | 8p22-p21.3 | 0.520 | 0.005525 | −0.29683 | 0.36779 | 0.002779 | 147.826 | 0.25154 |
| 427 | ASAH1 | 8p22-p21.3 | 0.346 | 0.005525 | −0.29683 | 0.36779 | 0.004951 | 320.560 | 0.27290 |
| 137492 | VPS37A | 8p22 | 0.345 | 0.005525 | −0.29683 | 0.36779 | 0.002322 | 63.209 | 0.30503 |
| 23168 | RTF1 | 15q15.1 | 0.307 | 0.009133 | 1.92012 | 0.37105 | 0.006772 | 474.496 | 0.33460 |
| 22894 | DIS3 | 13q22.1 | 0.556 | 0.009654 | −0.38738 | 0.37967 | 0.004462 | 116.996 | 0.38537 |
| 79758 | DHRS12 | 13q14.3 | 0.306 | 0.005792 | −1.23763 | 0.38248 | 0.006945 | 85.112 | 0.32638 |
| 9724 | UTP14C | 13q14.2 | 0.561 | 0.005792 | −1.23763 | 0.38248 | 0.008019 | 388.998 | 0.41778 |
| 63905 | MANBAL | 20q11.23-q12 | 0.419 | 0.004877 | 0.71667 | 0.38535 | 0.004471 | 387.406 | 0.27355 |
| 51028 | VPS36 | 13q14.3 | 0.528 | 0.005619 | −1.31313 | 0.39240 | 0.001816 | 424.584 | 0.28698 |
| 10910 | SUGT1 | 13q14.3 | 0.445 | 0.005619 | −1.31313 | 0.39240 | 0.001911 | 581.822 | 0.32636 |
| 57511 | COG6 | 13q13.3 | 0.399 | 0.007829 | −1.24369 | 0.39496 | 0.001745 | 207.144 | 0.32600 |
| 55739 | FLJ10769 | 13q34 | 0.335 | 0.006885 | −1.13698 | 0.39608 | 0.006258 | 190.028 | 0.36051 |
| 6905 | TBCE | 1q42.3 | 0.304 | 0.005412 | 1.50157 | 2.53491 | 0.006834 | 45.930 | 2.76814 |
| 6894 | TARBP1 | 1q42.3 | 0.359 | 0.004699 | 1.91168 | 2.87681 | 0.003343 | 366.391 | 2.97607 |
| 9816 | KIAA0133 | 1q42.13 | 0.396 | 0.001311 | 0.73573 | 2.93120 | 0.004780 | 270.922 | 2.98515 |
| 10228 | STX6 | 1q25.3 | 0.536 | 0.001067 | 0.61169 | 3.03101 | 0.000999 | 177.185 | 2.98055 |
| 25782 | RAB3GAP2 | 1q41 | 0.544 | 0.001051 | 1.74582 | 3.07006 | 0.003685 | 235.189 | 2.87489 |
| 51160 | VPS28 | 8q24.3 | 0.425 | 0.003538 | 1.44971 | 3.08220 | 0.005678 | 864.807 | 4.10809 |
| 4233 | MET | 7q31 | 0.323 | 0.004043 | −0.23912 | 3.16629 | 0.003740 | 206.302 | 2.72463 |
| 6635 | SNRPE | 1q32 | 0.328 | 0.000299 | 1.79083 | 3.24363 | 0.000353 | 3,177.945 | 4.15394 |
| 25879 | WDSOF1 | 8q22.3 | 0.373 | 0.000640 | 0.13350 | 3.29000 | 0.000000 | 887.619 | 11.77023 |
| 9791 | PTDSS1 | 8q22 | 0.308 | 0.001387 | 0.30507 | 3.39381 | 0.002064 | 812.407 | 12.24873 |
| 11124 | FAF1 | 1p33 | 0.533 | 0.000897 | 0.44852 | 3.39457 | 0.001280 | 57.236 | 4.93055 |
| 29920 | PYCR2 | 1q42.12 | 0.330 | 0.004088 | 2.83916 | 3.39550 | 0.002543 | 1,171.205 | 2.79468 |
| 51133 | KCTD3 | 1q41 | 0.328 | 0.000205 | 0.06059 | 3.44122 | 0.000957 | 125.904 | 3.16757 |
| 7534 | YWHAZ | 8q23.1 | 0.364 | 0.001137 | 0.95636 | 3.45697 | 0.000048 | 3,782.327 | 5.53711 |
| 824 | CAPN2 | 1q41-q42 | 0.330 | 0.001729 | 2.19739 | 3.51975 | 0.009564 | 3,902.497 | 2.70797 |
| 55758 | RCOR3 | 1q32.2-q32.3 | 0.358 | 0.001730 | 2.43104 | 3.52583 | 0.001874 | 116.894 | 2.89591 |
| 9926 | LPGAT1 | 1q32 | 0.300 | 0.001730 | 2.43104 | 3.52583 | 0.001402 | 115.416 | 3.42912 |
| 4751 | NEK2 | 1q32.2-q41 | 0.396 | 0.001730 | 2.43104 | 3.52583 | 0.000010 | 79.945 | 6.84130 |
| 114926 | C8orf40 | 8p11.21 | 0.314 | 0.005614 | 1.48256 | 3.56760 | 0.003316 | 996.430 | 3.64199 |
| 51105 | PHF20L1 | 8q24.22 | 0.414 | 0.000264 | 0.16457 | 3.60465 | 0.000015 | 319.628 | 5.68284 |
| 25909 | AHCTF1 | 1q44 | 0.305 | 0.002450 | 2.69159 | 3.60771 | 0.007309 | 82.854 | 9.79129 |
| 57645 | POGK | 1q24.1 | 0.484 | 0.000179 | 2.00992 | 3.66639 | 0.002933 | 478.484 | 2.76123 |
| 261726 | TIPRL | 1q23.2 | 0.455 | 0.000179 | 2.00992 | 3.66639 | 0.002129 | 430.151 | 4.59311 |
| 1994 | ELAVL1 | 19p13.2 | 0.384 | 0.009193 | 3.86989 | 3.70359 | 0.000003 | 712.201 | 7.85708 |
| 55699 | IARS2 | 1q41 | 0.412 | 0.000456 | 2.18196 | 3.80597 | 0.000827 | 1,646.688 | 5.21163 |
| 83540 | NUF2 | 1q23.3 | 0.584 | 0.000051 | 1.79446 | 3.90542 | 0.002608 | 28.444 | 2.94259 |
| 8490 | RGS5 | 1q23.1 | 0.382 | 0.000051 | 1.79446 | 3.90542 | 0.000395 | 45.035 | 6.44920 |
| 23596 | OPN3 | 1q43 | 0.406 | 0.000341 | 2.14760 | 3.91372 | 0.000033 | 801.608 | 5.65836 |
| 10806 | SDCCAG8 | 1q43-q44 | 0.328 | 0.000080 | 1.77985 | 3.96109 | 0.000247 | 138.152 | 3.39518 |
| 9859 | CEP170 | 1q44 | 0.429 | 0.000080 | 1.77985 | 3.96109 | 0.008791 | 181.213 | ####### |
| 6667 | SP1 | 12q13.1 | 0.304 | 0.002478 | 1.69584 | 3.97988 | 0.002084 | 106.701 | 2.91738 |
| 79848 | CSPP1 | 8q13.2 | 0.311 | 0.001985 | 1.20480 | 4.02268 | 0.000022 | 137.192 | 4.72529 |
| 23246 | BOP1 | 8q24.3 | 0.360 | 0.005043 | 2.05116 | 4.04435 | 0.000005 | 457.369 | 6.23796 |
| 26233 | FBXL6 | 8q24.3 | 0.314 | 0.005043 | 2.05116 | 4.04435 | 0.000000 | 227.012 | 12.12671 |
| 9917 | FAM20B | 1q25 | 0.354 | 0.000023 | 0.80561 | 4.07069 | 0.000034 | 298.079 | 4.41041 |
| 8476 | CDC42BPA | 1q42.11 | 0.426 | 0.000123 | 2.05400 | 4.07676 | 0.002344 | 31.784 | 2.99120 |
| 2138 | EYA1 | 8q13.3 | 0.310 | 0.001330 | 0.67551 | 4.21010 | 0.001317 | 128.692 | 2.84909 |
| 1063 | CENPF | 1q32-q41 | 0.340 | 0.000016 | 1.69148 | 4.21882 | 0.005668 | 402.702 | 4.05421 |
| 5087 | PBX1 | 1q23 | 0.363 | 0.000011 | 1.79446 | 4.32087 | 0.001165 | 76.263 | 2.93859 |
| 4931 | NVL | 1q41-q42.2 | 0.358 | 0.000379 | 2.69857 | 4.36394 | 0.002058 | 213.747 | 3.51441 |
| 51377 | UCHL5 | 1q32 | 0.330 | 0.000006 | 1.30478 | 4.36932 | 0.003503 | 593.428 | 4.27175 |
| 27161 | EIF2C2 | 8q24 | 0.304 | 0.000353 | 1.13473 | 4.40659 | 0.000679 | 536.399 | 4.31660 |
| 51571 | FAM49B | 8q24.21 | 0.329 | 0.000076 | 0.59612 | 4.41206 | 0.000314 | 856.912 | 5.87029 |
| 54512 | EXOSC4 | 8q24.3 | 0.359 | 0.000294 | 1.47113 | 4.48101 | 0.001694 | 342.522 | 3.72761 |
| 51236 | C8orf30A | 8q24.3 | 0.324 | 0.000294 | 1.47113 | 4.48101 | 0.000395 | 626.501 | 4.42996 |
| 22827 | PUF60 | 8q24.2-qter | 0.329 | 0.000294 | 1.47113 | 4.48101 | 0.000000 | 866.272 | 10.29501 |
| 1537 | CYC1 | 8q24.3 | 0.351 | 0.000294 | 1.47113 | 4.48101 | 0.000000 | 1,503.234 | 12.29360 |
| 54704 | PPM2C | 8q22.1 | 0.330 | 0.000081 | 0.68166 | 4.62002 | 0.000149 | 364.828 | 4.15633 |
| 259266 | ASPM | 1q31 | 0.419 | 0.000005 | 1.26366 | 4.79025 | 0.001951 | 153.463 | 2.85434 |
| 81563 | C1orf21 | 1q25 | 0.447 | 0.000005 | 1.80843 | 4.79025 | 0.003290 | 112.360 | 3.47709 |
| 80267 | EDEM3 | 1q24-q25 | 0.373 | 0.000005 | 1.80843 | 4.79025 | 0.000326 | 890.674 | 3.56200 |
| 116461 | C1orf19 | 1q25 | 0.485 | 0.000005 | 1.80843 | 4.79025 | 0.000111 | 721.695 | 5.10587 |
| 83593 | RASSF5 | 1q32.1 | 0.477 | 0.000005 | 2.29093 | 4.88201 | 0.000061 | 1,412.560 | 3.99044 |
| 56943 | ENY2 | 8q23.1 | 0.376 | 0.000037 | 0.04664 | 5.03608 | 0.000476 | 978.747 | 5.57678 |
| 5339 | PLEC1 | 8q24 | 0.348 | 0.000007 | 1.47113 | 5.17341 | 0.000493 | 109.874 | 3.20045 |
| 80342 | TRAF3IP3 | 1q32.3-q41 | 0.353 | 0.000001 | 1.71453 | 5.21910 | 0.002288 | 344.460 | 2.78001 |
| 27042 | C1orf107 | 1q32.2 | 0.393 | 0.000001 | 1.71453 | 5.21910 | 0.000665 | 242.990 | 3.22740 |
| 51018 | RRP15 | 1q41 | 0.390 | 0.000017 | 1.70767 | 5.95527 | 0.000052 | 304.232 | 3.77823 |
| 117145 | THEM4 | 1q21 | 0.508 | 0.000002 | 3.36864 | 6.20947 | 0.008772 | 309.537 | 3.09579 |
| 6281 | S100A10 | 1q21 | 0.422 | 0.000002 | 3.36864 | 6.20947 | 0.000013 | 1,639.060 | 6.09657 |
| 4063 | LY9 | 1q21.3-q22 | 0.381 | 0.000004 | 3.03092 | 6.33654 | 0.000030 | 1,196.649 | 5.30224 |
| 257106 | ARHGAP30 | 1q23.3 | 0.530 | 0.000004 | 3.03092 | 6.33654 | 0.000143 | 1,007.791 | 5.31337 |
| 286128 | ZFP41 | 8q24.3 | 0.328 | 0.000017 | 1.47113 | 6.45256 | 0.002637 | 81.867 | 3.04358 |
| 4061 | LY6E | 8q24.3 | 0.374 | 0.000017 | 1.47113 | 6.45256 | 0.000900 | 1,177.185 | 4.18986 |
| 4921 | DDR2 | 1q23.3 | 0.408 | 0.000012 | 2.57783 | 6.54142 | 0.003233 | 151.890 | 2.63592 |
| 126823 | KLHDC9 | 1q23.3 | 0.436 | 0.000012 | 3.72859 | 6.54142 | 0.002879 | 176.677 | 2.72366 |
| 84134 | TOMM40L | 1q23.3 | 0.350 | 0.000012 | 3.72859 | 6.54142 | 0.008729 | 253.861 | 2.93794 |
| 4817 | NIT1 | 1q21-q22 | 0.384 | 0.000012 | 3.72859 | 6.54142 | 0.003099 | 381.858 | 4.43113 |
| 4720 | NDUFS2 | 1q23 | 0.450 | 0.000012 | 3.72859 | 6.54142 | 0.000772 | 1,207.561 | 4.61835 |
| 9722 | NOS1AP | 1q23.3 | 0.347 | 0.000012 | 2.57783 | 6.54142 | 0.000312 | 240.574 | 4.66892 |
| 9191 | DEDD | 1q23.3 | 0.470 | 0.000012 | 3.72859 | 6.54142 | 0.000804 | 428.711 | 5.11067 |
| 5498 | PPOX | 1q22 | 0.438 | 0.000012 | 3.72859 | 6.54142 | 0.000002 | 344.634 | 6.14992 |
| 6391 | SDHC | 1q23.3 | 0.457 | 0.000012 | 3.72859 | 6.54142 | 0.000004 | 1,045.238 | 7.51373 |
| 8703 | B4GALT3 | 1q21-q23 | 0.349 | 0.000012 | 3.72859 | 6.54142 | 0.000000 | 2,474.098 | 10.73123 |
| 7175 | TPR | 1q25 | 0.438 | 0.000002 | 2.10344 | 6.83269 | 0.003477 | 836.585 | 2.73452 |
| 55732 | C1orf112 | 1q24.2 | 0.520 | 0.000002 | 2.21589 | 6.83269 | 0.005653 | 94.521 | 3.96762 |
| 10625 | IVNS1ABP | 1q25.1-q31.1 | 0.357 | 0.000001 | 2.10344 | 6.92370 | 0.000025 | 394.043 | 4.57452 |
| 55157 | DARS2 | 1q25.1 | 0.579 | 0.000000 | 2.31138 | 6.97720 | 0.005076 | 179.320 | 2.53709 |
| 91687 | CENPL | 1q25.1 | 0.596 | 0.000000 | 2.31138 | 6.97720 | 0.002323 | 49.664 | 2.81575 |
| 27101 | CACYBP | 1q24-q25 | 0.501 | 0.000000 | 2.31138 | 6.97720 | 0.001626 | 359.370 | 3.60239 |
| 29922 | NME7 | 1q24 | 0.330 | 0.000000 | 2.21589 | 6.97720 | 0.003542 | 212.116 | 3.85501 |
| 27252 | KLHL20 | 1q24.1-q24.3 | 0.472 | 0.000000 | 2.31138 | 6.97720 | 0.002083 | 229.135 | 4.63432 |
| 63931 | MRPS14 | 1q23-q25 | 0.419 | 0.000000 | 2.31138 | 6.97720 | 0.000000 | 1,455.272 | 10.34099 |
| 22920 | KIFAP3 | 1q24.2 | 0.444 | 0.000000 | 2.21589 | 7.49983 | 0.003813 | 467.545 | 2.61117 |
| 7371 | UCK2 | 1q23 | 0.364 | 0.000000 | 2.71008 | 7.61879 | 0.003297 | 661.499 | 3.54124 |
| 79005 | SCNM1 | 1q21.2 | 0.468 | 0.000000 | 3.94993 | 7.86540 | 0.009839 | 541.274 | 2.39475 |
| 6944 | VPS72 | 1q21 | 0.533 | 0.000000 | 3.94993 | 7.86540 | 0.007205 | 489.708 | 2.47252 |
| 51107 | APHIA | 1p36.13-q31.3 | 0.446 | 0.000000 | 3.94993 | 7.86540 | 0.006212 | 654.353 | 2.53528 |
| 10654 | PMVK | 1q22 | 0.463 | 0.000000 | 3.89627 | 7.86540 | 0.006463 | 396.927 | 2.57529 |
| 3570 | IL6R | 1q21 | 0.537 | 0.000000 | 3.89627 | 7.86540 | 0.001332 | 121.056 | 2.95473 |
| 23248 | KIAA0460 | 1q21.2 | 0.494 | 0.000000 | 3.94993 | 7.86540 | 0.001625 | 1,402.811 | 2.98856 |
| 148327 | CREB3L4 | 1q21.3 | 0.513 | 0.000000 | 3.89627 | 7.86540 | 0.002408 | 230.007 | 3.01846 |
| 7170 | TPM3 | 1q21.2 | 0.429 | 0.000000 | 3.89627 | 7.86540 | 0.000957 | 2,283.616 | 3.01994 |
| 9898 | UBAP2L | 1q21.3 | 0.404 | 0.000000 | 3.89627 | 7.86540 | 0.000902 | 748.167 | 3.17808 |
| 27246 | ZNF364 | 1q21.1 | 0.320 | 0.000000 | 3.81258 | 7.86540 | 0.001687 | 399.393 | 3.19708 |
| 10623 | POLR3C | 1q21.1 | 0.469 | 0.000000 | 3.81258 | 7.86540 | 0.001755 | 293.617 | 3.20365 |
| 5710 | PSMD4 | 1q21.2 | 0.466 | 0.000000 | 3.94993 | 7.86540 | 0.003611 | 1,535.444 | 3.20649 |
| 80222 | TARS2 | 1q21.2 | 0.407 | 0.000000 | 3.94993 | 7.86540 | 0.003432 | 278.336 | 3.25469 |
| 1163 | CKS1B | 1q21.2 | 0.559 | 0.000000 | 3.89627 | 7.86540 | 0.001556 | 747.207 | 3.25535 |
| 2029 | ENSA | 1q21.2 | 0.546 | 0.000000 | 3.94993 | 7.86540 | 0.007812 | 1,704.266 | 3.26560 |
| 57592 | ZNF687 | 1q21.2 | 0.326 | 0.000000 | 3.94993 | 7.86540 | 0.008969 | 570.051 | 3.31661 |
| 10262 | SF3B4 | 1q12-q21 | 0.578 | 0.000000 | 3.94993 | 7.86540 | 0.001112 | 1,153.027 | 3.45948 |
| 1513 | CTSK | 1q21 | 0.534 | 0.000000 | 3.94993 | 7.86540 | 0.001341 | 151.275 | 3.68140 |
| 9869 | SETDB1 | 1q21 | 0.481 | 0.000000 | 3.94993 | 7.86540 | 0.001083 | 440.029 | 3.87514 |
| 5692 | PSMB4 | 1q21 | 0.318 | 0.000000 | 3.94993 | 7.86540 | 0.006150 | 2,992.974 | 4.00774 |
| 9939 | RBM8A | 1q12 | 0.418 | 0.000000 | 3.81258 | 7.86540 | 0.000168 | 1,198.030 | 4.35611 |
| 65005 | MRPL9 | 1q21.2 | 0.494 | 0.000000 | 3.94993 | 7.86540 | 0.001075 | 1,102.694 | 4.47411 |
| 3608 | ILF2 | 1q21.3 | 0.422 | 0.000000 | 3.74568 | 7.86540 | 0.001075 | 2,231.775 | 4.47411 |
| 5298 | PI4KB | 1q21 | 0.478 | 0.000000 | 3.94993 | 7.86540 | 0.000976 | 660.709 | 4.52337 |
| 6464 | SHC1 | 1q21 | 0.324 | 0.000000 | 3.89627 | 7.86540 | 0.000761 | 952.489 | 4.68940 |
| 51463 | GPR89B | 1q21.1 | 0.449 | 0.000000 | 2.99684 | 7.86540 | 0.000189 | 1,337.040 | 4.91264 |
| 54964 | C1orf56 | 1q21.2 | 0.389 | 0.000000 | 3.94993 | 7.86540 | 0.000038 | 355.600 | 4.96842 |
| 405 | ARNT | 1q21 | 0.475 | 0.000000 | 3.94993 | 7.86540 | 0.000387 | 136.844 | 5.04727 |
| 93183 | PIGM | 1q23.2 | 0.410 | 0.000000 | 2.83114 | 7.86540 | 0.000071 | 773.007 | 5.11181 |
| 51603 | KIAA0859 | 1q24-q25.3 | 0.484 | 0.000000 | 2.59359 | 7.86540 | 0.000106 | 491.378 | 5.66001 |
| 9557 | CHD1L | 1q12 | 0.512 | 0.000000 | 2.99684 | 7.86540 | 0.000345 | 746.675 | 5.86837 |
| 57198 | ATP8B2 | 1q21.3 | 0.386 | 0.000000 | 3.89627 | 7.86540 | 0.000085 | 4,532.166 | 5.87027 |
| 54460 | MRPS21 | 1q21.2 | 0.366 | 0.000000 | 3.94993 | 7.86540 | 0.000210 | 1,874.227 | 6.08512 |
| 80308 | FLAD1 | 1q21.3 | 0.407 | 0.000000 | 3.89627 | 7.86540 | 0.000001 | 245.750 | 6.41922 |
| 10903 | MTMR11 | 1q12-q21 | 0.381 | 0.000000 | 3.94993 | 7.86540 | 0.000000 | 184.092 | 8.01752 |
| 56882 | CDC42SE1 | 1q21.2 | 0.604 | 0.000000 | 3.94993 | 7.86540 | 0.000006 | 959.005 | 8.50097 |
| 9214 | FAIM3 | 1q32.1 | 0.305 | 0.000001 | 2.57795 | 8.14777 | 0.006170 | 132.538 | 2.49445 |
| 1196 | CLK2 | 1q21 | 0.374 | 0.000001 | 3.89627 | 8.14777 | 0.009745 | 631.609 | 2.59868 |
| 5546 | PRCC | 1q21.1 | 0.486 | 0.000001 | 3.89627 | 8.14777 | 0.008183 | 293.251 | 2.70376 |
| 10712 | C1orf2 | 1q21 | 0.507 | 0.000001 | 3.89627 | 8.14777 | 0.002447 | 606.058 | 2.74614 |
| 28956 | MAPBPIP | 1q22 | 0.452 | 0.000001 | 3.89627 | 8.14777 | 0.006379 | 544.288 | 2.79917 |
| 29089 | UBE2T | 1q32.1 | 0.348 | 0.000001 | 3.28991 | 8.14777 | 0.005473 | 263.049 | 3.09604 |
| 25778 | RIPK5 | 1q32.1 | 0.467 | 0.000001 | 3.59842 | 8.14777 | 0.000514 | 80.188 | 3.11959 |
| 2005 | ELK4 | 1q32 | 0.481 | 0.000001 | 3.59842 | 8.14777 | 0.005824 | 71.918 | 3.53159 |
| 10092 | ARPC5 | 1q25.3 | 0.493 | 0.000001 | 2.90548 | 8.14777 | 0.000202 | 520.685 | 3.56601 |
| 9181 | ARHGEF2 | 1q21-q22 | 0.527 | 0.000001 | 3.89627 | 8.14777 | 0.001152 | 141.310 | 3.59139 |
| 54865 | GPATCH4 | 1q22 | 0.442 | 0.000001 | 3.89627 | 8.14777 | 0.000315 | 274.801 | 3.81110 |
| 9928 | KIF14 | 1q32.1 | 0.473 | 0.000001 | 3.28991 | 8.14777 | 0.000584 | 105.709 | 3.91625 |
| 2224 | FDPS | 1q22 | 0.389 | 0.000001 | 3.89627 | 8.14777 | 0.001471 | 827.189 | 3.97280 |
| 10067 | SCAMP3 | 1q21 | 0.349 | 0.000001 | 3.89627 | 8.14777 | 0.000850 | 1,231.408 | 4.22301 |
| 92703 | TMEM183A | 1q32.1 | 0.450 | 0.000001 | 3.28991 | 8.14777 | 0.003970 | 959.921 | 4.30052 |
| 6051 | RNPEP | 1q32 | 0.401 | 0.000001 | 3.28991 | 8.14777 | 0.003475 | 776.973 | 4.33207 |
| 64710 | NUCKS1 | 1q32.1 | 0.347 | 0.000001 | 3.59842 | 8.14777 | 0.002958 | 308.429 | 4.44254 |
| 252839 | TMEM9 | 1q32.1 | 0.312 | 0.000001 | 3.28991 | 8.14777 | 0.001731 | 1,011.952 | 4.73215 |
| 23046 | KIF21B | 1pter-q31.3 | 0.526 | 0.000001 | 3.28991 | 8.14777 | 0.000077 | 583.088 | 4.73691 |
| 7818 | DAP3 | 1q21-q22 | 0.346 | 0.000001 | 3.89627 | 8.14777 | 0.000540 | 1,394.582 | 4.82882 |
| 54856 | GON4L | 1q22 | 0.403 | 0.000001 | 3.89627 | 8.14777 | 0.000095 | 150.529 | 5.16453 |
| 10440 | TIMM17A | 1q32.1 | 0.451 | 0.000001 | 3.28991 | 8.14777 | 0.000230 | 2,032.111 | 5.26391 |
| 1604 | CD55 | 1q32 | 0.388 | 0.000001 | 2.57795 | 8.14777 | 0.000205 | 1,963.138 | 5.31944 |
| 81875 | ISG20L2 | 1q23.1 | 0.545 | 0.000001 | 3.89627 | 8.14777 | 0.000073 | 640.585 | 5.33688 |
| 7203 | CCT3 | 1q23 | 0.404 | 0.000001 | 3.89627 | 8.14777 | 0.000020 | 2,762.731 | 6.02642 |
| 55154 | MSTO1 | 1q22 | 0.358 | 0.000001 | 3.89627 | 8.14777 | 0.000007 | 506.720 | 6.08865 |
| 55432 | YOD1 | 1q32.1 | 0.363 | 0.000001 | 2.57795 | 8.14777 | 0.000000 | 319.257 | 7.36186 |
| 8407 | TAGLN2 | 1q21-q25 | 0.391 | 0.000001 | 2.89832 | 8.14777 | 0.000000 | 732.284 | 8.22606 |
| 7994 | MYST3 | 8p11 | 0.494 | 0.000000 | 1.15191 | 8.22393 | 0.002192 | 85.313 | 4.62426 |
| 962 | CD48 | 1q21.3-q22 | 0.374 | 0.000000 | 2.86319 | 9.22499 | 0.008219 | 6,663.755 | 2.87774 |
| 5824 | PEX19 | 1q22 | 0.516 | 0.000000 | 2.83114 | 9.22499 | 0.002984 | 378.404 | 3.94304 |

### EXAMPLE 23

### Copy Number Abnormalities at 8q24 Increase EIF2C2/AGO2 Copy Number and Gene Expression and Influence Survival

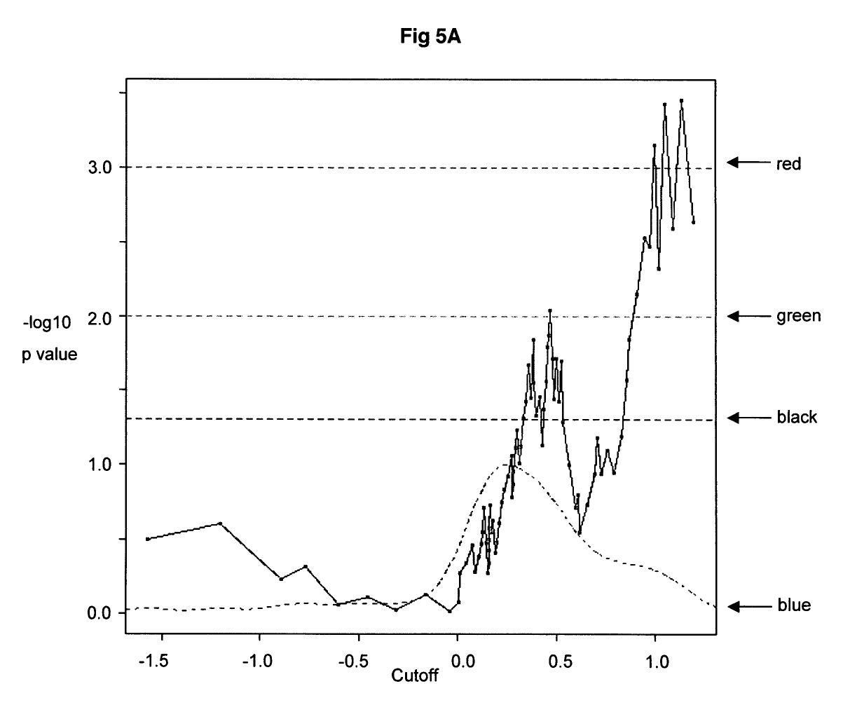

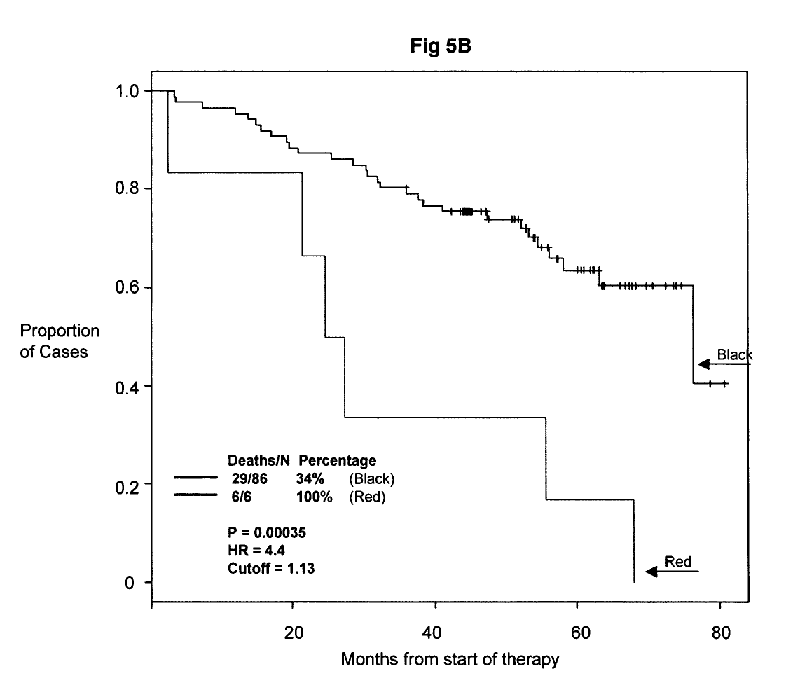

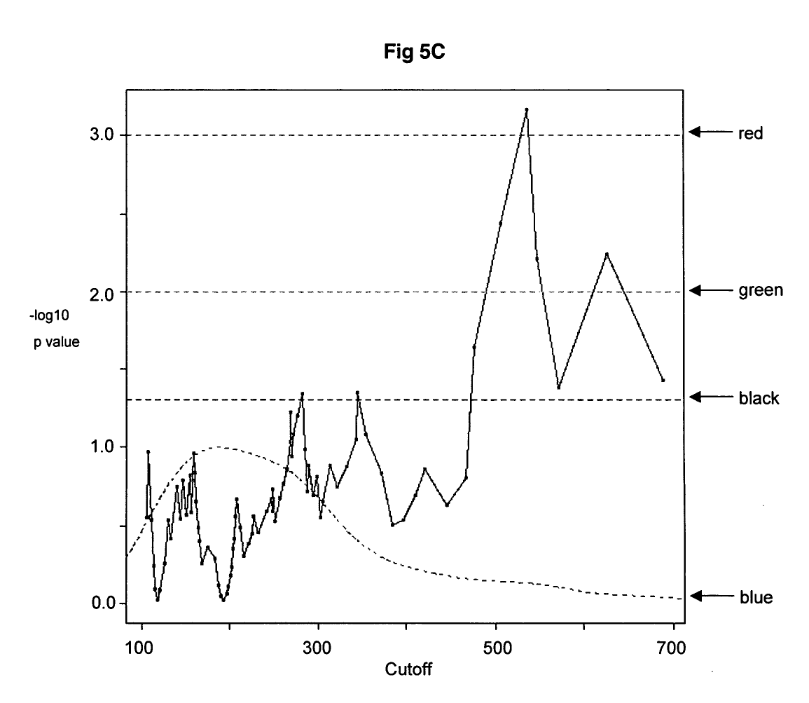

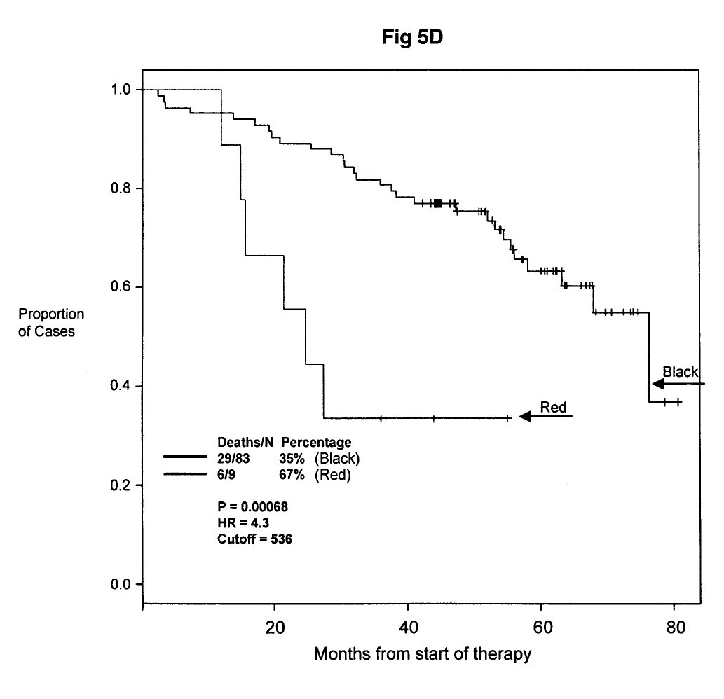

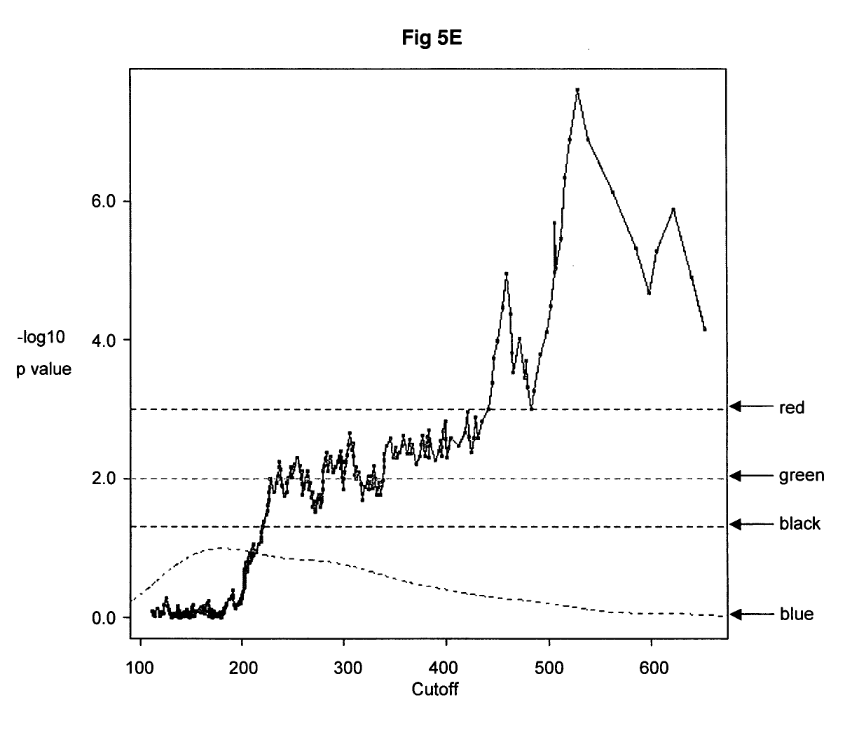

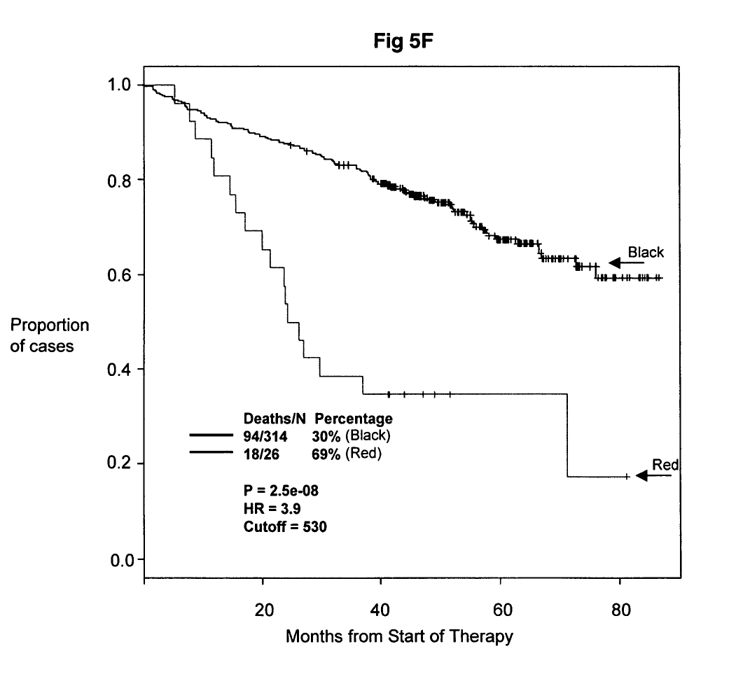

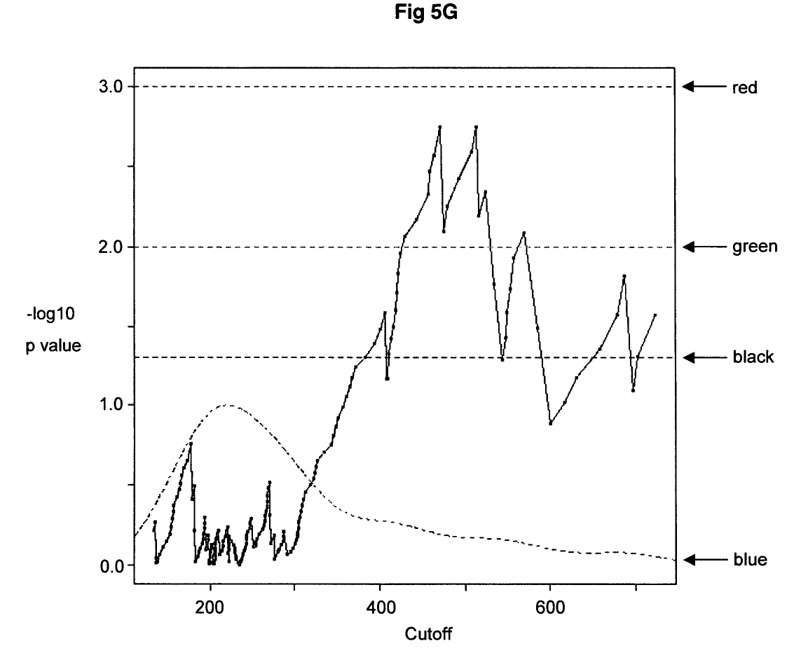

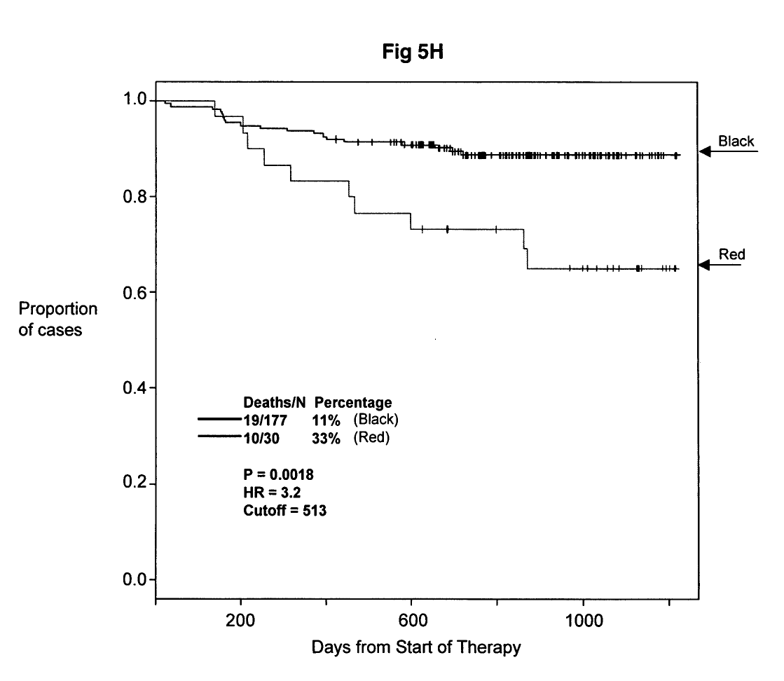

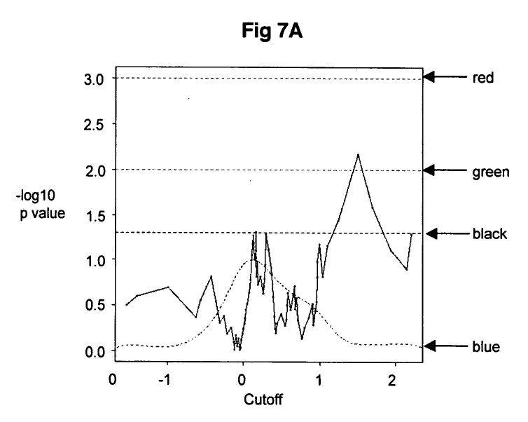

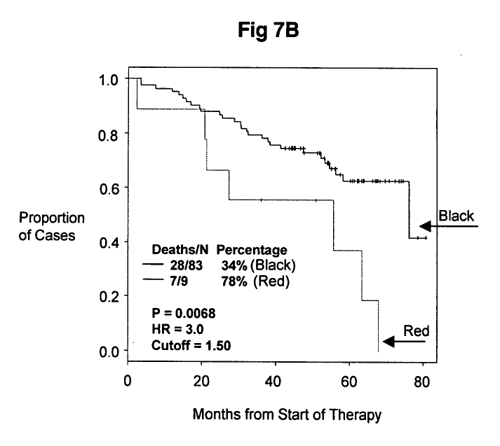

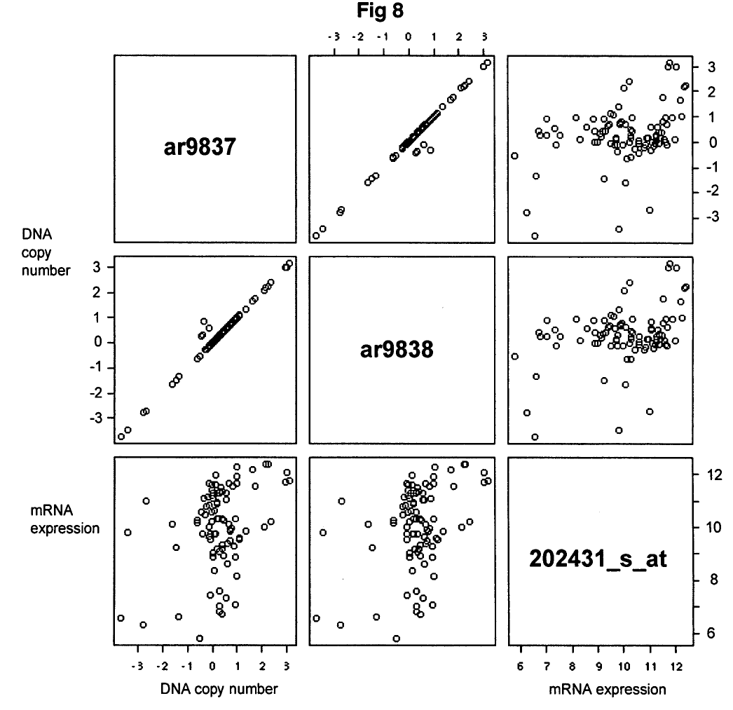

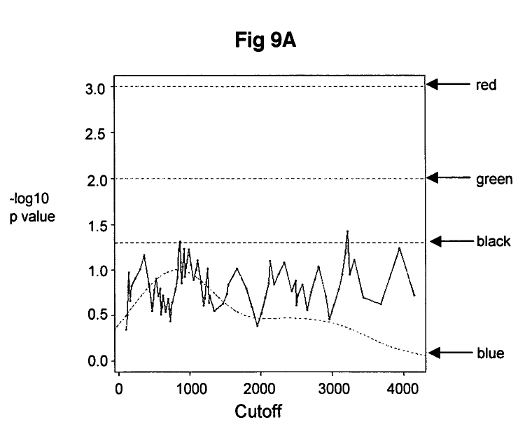

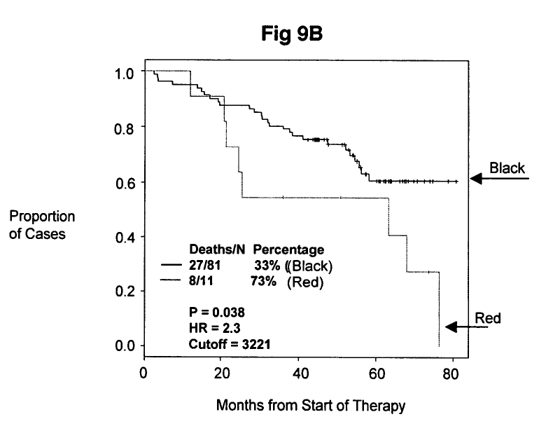

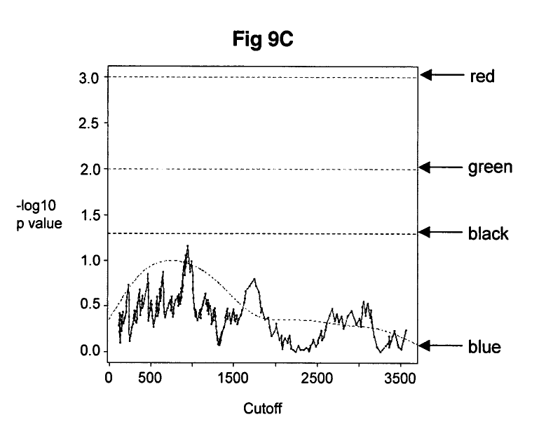

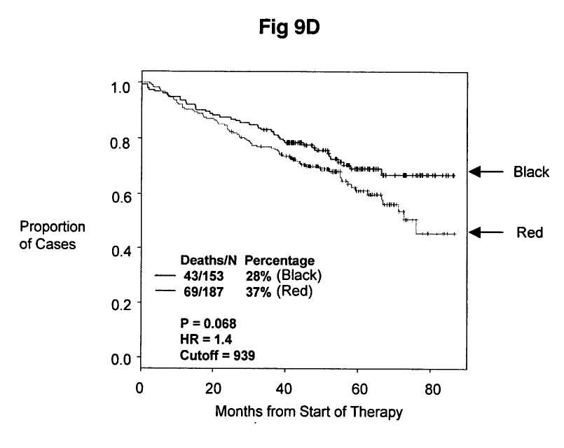

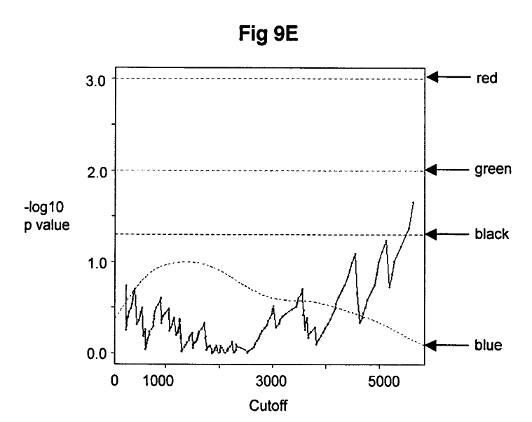

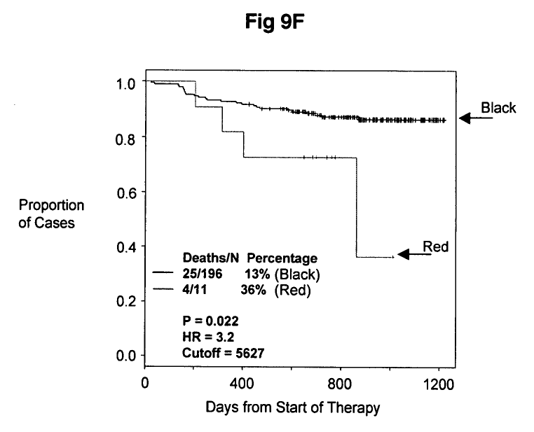

One of the 210 candidate genes, EIF2C2/AGO2, is of high interest since it is a protein that binds to miRNAs, and by corollary, mRNA translation and/or mRNA degradation (Liu et al, 2004), and an additional function of regulating the products of mature miRNAs (O'Carroll et al, 2007; Diederichs and Haber, 2007). Importantly, recent studies have revealed that EIF2C2/AGO2 plays an essential function in B-cell differentiation (O'Carroll et al, 2007, Martinez et al, 2007). EIF2C2/AGO2 is represented by five probes on our Agilent 244K array comparative genomic hybridization platform, which are all located in the same atom region. While EIF2C2/AGO2 also has six probes on the Affymetrix U133PLUS2.0 GENECHIP®, only one probe, 225827_at maps exactly to exons of EIF2C2/AGO2 according to National Center for Biotechnology Information gene database and this probe was used to evaluate expression of EIF2C2/AGO2. The correlation co-efficient of DNA copy number and expression level of EIF2C2/AGO2 was 0.304. The optimized P-value of a log-rank test was 0.00035 and 0.00068 for array comparative genomic hybridization and gene expression data, respectively (FIGS. 5A-5D). We next investigated the relationship between expression of EIF2C2/AGO2 and outcome in two additional publicly available gene expression datasets (FIGS. 5E-5H). Elevated EIF2C2/AGO2 expression was associated with poor outcome in these datasets as well. We next performed multivariate analysis with EIF2C2/AGO2 and common prognostic factors in Total Therapy 2 (Table 8) and Total Therapy 3 datasets (Table 9). These results suggested EIF2C2/AGO2 is an independent prognostic variable in both datasets. Since the MYC oncogene maps to 8q24 and its de-regulation is seen in a variety of cancers, we next investigated copy number and expression relationships with outcome in these datasets. The results revealed that while MYC was in a copy number abnormality associated with poorer outcome (FIGS. 7A-7B), MYC expression was not significantly associated with copy number abnormalities (FIG. 8) and MYC expression was not associated with outcome in the 92 patient cohort and in the both validation gene expression datasets (P>0.01) (FIGS. 9A-9F).

TABLE 8
Multivariate analysis of overall survival in Total Therapy 2 with AGO2.

| | Variable | n/N (%) | HR (95% CI)* | P-value |
|---|---|---|---|---|
| Univariate | Age >= 65 yrs | 69/340 (20%) | 1.32 (0.85, 2.05) | 0.21 |
| | Hb < 10 g/dL | 92/340 (27%) | 1.24 (0.84, 1.83) | 0.27 |
| | Caucasian Ethnicity | 301/340 (86%) | 1.26 (0.69, 2.32) | 0.45 |
| | Female | 146/340 (43%) | 0.88 (0.60, 1.28) | 0.49 |
| | CRP >= 8.0 mg/L | 121/340 (36%) | 1.16 (0.80, 1.70) | 0.42 |
| | Albumin < 3.5 g/dL | 52/340 (15%) | 1.65 (1.04, 2.61) | 0.029 |
| | Creatinine >= 2.0 mg/dL | 35/340 (10%) | 2.64 (1.64, 4.25) | 0.000048 |
| | LDH >= 190 U/L | 114/340 (34%) | 2.12 (1.47, 3.06) | 0.000046 |
| | B2M >= 3.5 mg/L | 137/340 (40%) | 2.03 (1.41, 2.93) | 0.00011 |
| | B2M > 5.5 mg/L | 68/340 (20%) | 2.25 (1.51, 3.35) | 0.000045 |
| | Cytogenetics abnormalities | 108/340 (32%) | 2.32 (1.63, 3.40) | 0.0000031 |
| | 70 gene-defined high-risk | 45/340 (13%) | 4.50 (2.96, 6.83) | 6.1E−13 |
| | TP53 (201746_at) < 136 | 36/340 (11%) | 0.49 (0.30, 0.82) | 0.0049 |
| | AGO2 (225827_at) > 530 | 26/340 (8%) | 3.68 (2.19, 6.18) | 0.00000053 |
| | t(4; 14) | 48/340 (14%) | 2.09 (1.35, 3.24) | 0.00073 |
| | Proliferation Index | 36/340 (11%) | 3.88 (2.46, 6.14) | 3.3E−09 |
| Multivariate | B2M >= 3.5 mg/L | 137/340 (40%) | 1.64 (1.10, 2.45) | 0.014 |
| | Cytogenetics abnormalities | 108/340 (32%) | 1.58 (1.05, 2.37) | 0.026 |
| | 70 gene-defined high-risk | 45/340 (13%) | 2.13 (1.23, 3.69) | 0.0062 |
| | TP53 (201746_at) < 136 | 36/340 (11%) | 0.45 (0.26, 0.76) | 0.0021 |
| | AGO2 (225827_at) > 530 | 26/340 (8%) | 2.17 (1.23, 3.83) | 0.0062 |
| | t(4; 14) | 48/340 (14%) | 2.07 (1.32, 3.25) | 0.0012 |
| | Proliferation Index | 36/340 (11%) | 1.67 (0.92, 3.02) | 0.082 |

TABLE 9
Multiple variable analysis of AGO2 in Total Therapy 3.

| | Overall Survival | | | |
|---|---|---|---|---|
| | Variable | n/N (%) | HR (95% CI)* | P-value |
| Univariate | Age >= 65 | 58/206 (28%) | 1.66 (0.82, 3.36) | 0.15 |
| | HGB < 10 g/dL | 62/206 (30%) | 1.59 (0.78, 3.23) | 0.19 |
| | Caucasian Ethnicity | 181/206 (88%) | 0.81 (0.28, 2.35) | 0.69 |
| | Female | 70/206 (34%) | 1.67 (0.84, 3.34) | 0.14 |
| | CRP >= 8 mg/L | 66/206 (32%) | 2.29 (1.15, 4.55) | 0.016 |
| | Albumin < 3.5 g/dL | 41/206 (20%) | 2.21 (1.06, 4.62) | 0.03 |
| | Creatinine >= 2.0 mg/dL | 18/206 (9%) | 3.32 (1.42, 7.79) | 0.0048 |
| | LDH >= 190 U/L | 54/206 (26%) | 3.66 (1.84, 7.28) | 0.03 |
| | B2M >= 3.5 mg/L | 94/206 (46%) | 2.14 (1.06, 4.35) | 0.031 |
| | B2M > 5.5 mg/L | 42/206 (20%) | 3.35 (1.67, 6.70) | 0.00049 |
| | Cytogenetic abnormalities | 71/206 (34%) | 3.59 (1.77, 7.29) | 0.00031 |
| | 70 gene-defined high-risk | 31/206 (15%) | 4.41 (2.17, 8.98) | 2.9E−05 |
| | TP53 (201746_at) < 136 | 18/206 (9) | 0.43 (0.17, 1.05) | 0.06 |
| | AGO2 (225827_at) > 530 | 28/206 (13%) | 3.47 (1.69, 7.14) | 0.00056 |
| | t(4; 14) | 29/206 (14%) | 1.04 (0.39, 2.74) | 0.94 |
| | Proliferation Index | 40/206 (19%) | 3.09 (1.52, 6.27) | 0.0014 |
| Multivariate | LDH >= 190 U/L | 54/206 (26%) | 2.51 (1.22, 5.18) | 0.011 |
| | Cytogenetic abnormalities | 71/206 (34%) | 2.53 (1.17, 5.45) | 0.016 |
| | AGO2 (225827_at) > 530 | 28/206 (13%) | 2.94 (1.38, 6.27) | 0.0044 |
| | Age >= 65 | 58/206 (28%) | 2.15 (1.03, 4.50) | 0.037 |
| | Albumin < 3.5 g/dL | 41/206 (20%) | 2.20 (1.05, 4.63) | 0.034 |

*HR—Hazard Ratio, 95% CI—95% Confidence Interval, P-value from Wald Chi-Square Test in Cox Regression. (For Tables 8 and 9).

The following references are cited herein:
Alizadeh A A, et al, Nature 2000, 403: 503-511.
Auer H, et al, BMC Genomics, 2007, 8: 111.
Avet-Loiseau H, et al, Genes Chromosomes Cancer, 1997, 19: 124-133.
Barlogie B, et al, N Engl J Med, 2006, 354: 1021-1030.
Barlogie B, et al, Plasma cell myeloma. In: Marshall Al Lichtman E B, Kenneth Kaushansky, Thomas J. Kipps, Uri Seligsohn, Josef Prchal, editor. Williams Hematology, 2005, 7 ed. New York: McGraw-Hill Professional.
Barrett M T, et al, Proc Natl Acad Sci USA, 2004, 101: 17765-17770.
Bergsagel P L, Kuehl W M, Oncogene, 2001, 20: 5611-5622.
Calin G A et al, N Engl J Med, 2005, 353: 1793-1801.
Calin G A, Croce C M, Oncogene, 2006, 25: 6202-6210.
Calin G A, Croce C M, J Clin Invest, 2007, 117: 2059-2066.
Carrasco D R, et al, Cancer Cell, 2006, 9: 313-325.
Chang H, et al, Br J Haematol, 2007, 139: 51-54.
Chen L, et al, Exp Oncol 2007, 29: 116-120.
Chiecchio L, et al, Leukemia, 2006, 20: 1610-1617.
Cigudosa J C, et al, Blood, 1998, 91: 3007-3010.
Cremer F W, et al, Genes Chromosomes Cancer 2005, 44: 194-203.
Cuadros M, et al. J Clin Oncol, 2007, 25: 3321-3329.
Debes-Marun C S, et al, Leukemia, 2003, 17: 427-436.
Diederichs S, Haber D A, Cell, 2007, 131: 1097-1108.
Drach J, et al, Blood, 1998, 92: 802-809.
Feuk L, et al, Hum Mol Genet, 2006, 15 Spec No 1: R57-66.
Fonseca R, et al, Blood, 2003, 102: 2562-2567.
Fonseca R, et al, Cancer Res, 2004, 64: 1546-1558.
Gao C, et al, Proc Natl Acad Sci USA, 2007, 104: 8995-9000.
Gertz M A, et al, Blood, 2005, 106: 2837-2840.
Gutierrez N C, et al, Blood, 2004, 104: 2661-2666.
Hanamura I, et al, Blood, 2006 108: 1724-1732.
Houldsworth J, Chaganti R S, Am J Pathol, 1994, 145: 1253-1260.
Hyman E, et al, Cancer Res, 2002, 62: 6240-6245.
Iafrate A J, et al, Nat Genet, 2004, 36: 949-951.
Irizarry R A, et al, Biostatistics 2003, 4: 249-264.
Konigsberg R, et al. J Clin Oncol, 2000, 18: 804-812.
Kroger N, et al, Blood, 2004, 103: 4056-4061.
Kuehl W M, Bergsagel P L, Nat Rev Cancer, 2002, 2: 175-187.
Kumar S, Anderson K C, Nat Clin Pract Oncol, 2005, 2: 262-270.
Lee C, et al, Nat Genet, 2007, 39: S48-54.
Liebisch P, Dohner H, Eur J Cancer, 2006, 42: 1520-1529.
Liu J, et al, Science 2004, 305: 1437-1441.
Lupski J R, Stankiewicz P, PLoS Genet, 2005, 1: e49.
Martinez J, Busslinger M, Genes Dev, 2007, 21: 1983-1988.
Mohamed A N, et al, Am J Hematol, 2007, 82: 1080-1087.
O'Carroll D, et al, Genes Dev, 2007 21: 1999-2004.
Olshen A B, et al, Biostatistics, 2004, 5: 557-572.
Orsetti B, et al, Cancer Res, 2004, 64: 6453-6460.
Phillips J L, et al, Cancer Res, 2001, 61: 8143-8149.
Pinkel D, Albertson D G, Annu Rev Genomics Hum Genet, 2005a, 6: 331-354.
Pinkel D, Albertson D G, Nat Genet, 2005b, 37 Suppl: S11-17.
Pinkel D, et al, Nat Genet, 1998, 20: 207-211.
Platzer P, et al, Cancer Res, 2002, 62: 1134-1138.
Pollack J R, et al, Nat Genet 1999, 23: 41-46.
Pollack J R, et al, Proc Natl Acad Sci USA, 2002, 99: 12963-12968.
Qazilbash M H, et al, Biol Blood Marrow Transplant, 2007 13: 1066-1072.
Redon R, et al, Nature, 2006, 444: 444-454.
Rosenwald A, et al, Cancer Cell 2003, 3: 185-197.
Sebat J, et al, Science, 2004, 305: 525-528.
Sharp A J, et al, Nat Genet 2006, 38: 1038-1042.
Shaughnessy J, et al, Blood, 2000, 96: 1505-1511.
Shaughnessy J, et al, Blood, 2003, 101: 3849-3856.
Stallings R L, Trends Genet, 2007, 23: 278-283.
Tuzun E, et al, Nat Genet 2005, 37: 727-732.
Venkatraman E S, Olshen A B, Bioinformatics, 2007, 23: 657-663.
Walker B A, et al, Blood, 2006, 108: 1733-1743.
Wu K L, et al, Br J Haematol, 2007, 136: 615-623.
Xiong W, et al, Blood, 2008.
Yang Y H, et al, Nucleic Acids Res 2002, 30: e15.
Ylstra B, et al, Nucleic Acids Res 2006, 34: 445-450.
Zhan F, et al, Blood, 2002, 99: 1745-1757.
Zhan F, et al, Blood, 2006, 108: 2020-2028.
Zhan F, et al, Blood, 2007, 109: 4995-5001.
Zhan F, et al, Blood, 2008, 111: 968-969.
Zhang J, et al, Cytogenet Genome Res 2006, 115: 205-214.
Zojer N, et al, Blood 2000, 95: 1925-1930.

What is claimed is:

1. A method of detecting copy number abnormalities and gene expression profiling to identify genomic signatures linked to survival specific for a disease, comprising:
isolating plasma cells from individuals who suffer from a disease within a population and from individuals who do not suffer from the same disease within a population;
extracting nucleic acid from said plasma cells;
hybridizing said nucleic acid to DNA microarrays to determine copy number abnormalities and to determine expression levels of genes in the plasma cells; and
performing data analysis comprising bioinformatics and computational methodology, to identify an altered expression of disease candidate genes, wherein said altered expression is indicative of the specific genomic signatures linked to survival for said disease.

2. The method of claim 1, wherein said disease comprises multiple myeloma or classifications thereof.

3. The method of claim 2, wherein said classification of multiple myeloma comprises monoclonal gammopathy of undetermined significance, asymptomatic multiple myeloma, symptomatic multiple myeloma, or recurrent multiple myeloma.

4. The method of claim 1, wherein said DNA microarrays comprise an array comparative genomic hybridization to determine copy number abnormalities and a gene expression array to determine gene expression profiles.

5. The method of claim 1, wherein said disease candidate genes are selected from the group comprising ADAM5P, AGL, AHCTF1, AKR1C4, ALG14, ALPP, ANK2, ANKRD2, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A 7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

6. The method of claim 1, wherein said altered expression of said disease candidate genes comprises gain of expression, reduced expression, or both.

7. The method of claim 1, wherein said copy number abnormalities and altered gene expression, are detected by the methods comprising interphase fluorescent in situ hybridization, metaphase fluorescent in situ hybridization, PCR-based assays, protein-based assays, or a combination thereof.

8. A method of detecting a high-risk index and increased risk of death from progression of multiple myeloma, comprising:
isolating plasma cells from individuals who suffer from multiple myeloma within a population and from individuals who do not suffer from multiple myeloma within a population;
extracting nucleic acid from said plasma cells;
hybridizing said nucleic acid to a comparative genomic DNA array and to a gene expression DNA microarray to determine copy number abnormalities and to determine expression levels of genes in the plasma cells; and
performing data analysis comprising bioinformatics and computational methodology, to identify an altered expression of disease candidate genes and copy number abnormalities, wherein said altered expression of disease candidate genes and copy number abnormalities is indicative of a high-risk index and increased risk of death from progression of multiple myeloma.

9. The method of claim 8, wherein said multiple myeloma comprises monoclonal gammopathy of undetermined significance, asymptomatic multiple myeloma, symptomatic multiple myeloma, or recurrent multiple myeloma.

10. The method of claim 8, wherein said disease candidate genes are selected from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

11. The method of claim 8, wherein said altered expression of said disease candidate genes comprises gain of expression, reduced expression, or both.

12. The method of claim 8, wherein said copy number abnormalities and altered gene expression, are detected by the methods comprising interphase fluorescent in situ hybridization, metaphase fluorescent in situ hybridization, PCR-based assays, protein-based assays, or a combination thereof.

13. A method of detecting the potential for reduced survival in individuals with multiple myeloma, comprising:
isolating plasma cells from individuals who suffer from multiple myeloma within a population and from individuals who do not suffer from multiple myeloma within a population;
extracting nucleic acid from said plasma cells;
hybridizing said nucleic acid to a comparative genomic DNA array and to a gene expression DNA microarray to determine copy number abnormalities and expression levels of genes in the plasma cells; and
performing data analysis comprising bioinformatics and computational methodology, to identify an increased expression of the gene ARGONAUTE 2 (EIF2C2/AGO2) and copy number abnormalities involving gains at chromosome 8q24, wherein said increased expression of ARGONAUTE 2 and copy number abnormalities involving gains at chromosome 8q24 is indicative of a potential for reduced survival in the individual with multiple myeloma.

14. The method of claim 13, wherein said multiple myeloma comprises monoclonal gammopathy of undetermined significance, asymptomatic multiple myeloma, symptomatic multiple myeloma, or recurrent multiple myeloma.

15. The method of claim 13, wherein said copy number abnormalities and altered gene expression, are detected by the methods comprising interphase fluorescent in situ hybridization, metaphase fluorescent in situ hybridization, PCR-based assays, protein-based assays, or a combination thereof.

16. A method of detecting high risk of disease progression of multiple myeloma, comprising:
isolating plasma cells from individuals who suffer from multiple myeloma within a population and from individuals who do not suffer from multiple myeloma within a population;
extracting nucleic acid from said plasma cells;
hybridizing said nucleic acid to a comparative genomic DNA array and to a gene expression DNA microarray to determine copy number abnormalities and to determine expression levels of genes in the plasma cells; and
performing data analysis comprising bioinformatics and computational methodology, to identify an altered expression of disease candidate genes and copy number abnormalities, wherein said altered expression comprises loss of chromosome 1p DNA, loss of 1p gene expression, loss of 1 p protein expression, or a combination thereof, thereby indicating a high risk of disease progression of multiple myeloma.

17. The method of claim 16, wherein said multiple myeloma comprises monoclonal gammopathy of undetermined significance, asymptomatic multiple myeloma, symptomatic multiple myeloma, or recurrent multiple myeloma.

18. The method of claim 16, wherein said copy number abnormalities and altered gene expression, are detected by the methods comprising interphase fluorescent in situ hybridization, metaphase fluorescent in situ hybridization, PCR-based assays, protein-based assays, or a combination thereof.

19. A method of detecting high risk of disease progression of multiple myeloma, comprising:
isolating plasma cells from individuals who suffer from multiple myeloma within a population and from individuals who do not suffer from multiple myeloma within a population;
extracting nucleic acid from said plasma cells;
hybridizing said nucleic acid to a comparative genomic DNA array and to a gene expression DNA microarray to determine copy number abnormalities and to determine expression levels of genes in the plasma cells; and
performing data analysis comprising bioinformatics and computational methodology, to identify an altered expression of disease candidate genes and copy number abnormalities, wherein said altered expression comprises gain of chromosome 1q DNA, gain of 1q gene expression, gain of 1q protein expression, or a combination thereof, thereby indicating a high risk of disease progression of multiple myeloma.

20. The method of claim 19, wherein said multiple myeloma comprises monoclonal gammopathy of undetermined significance, asymptomatic multiple myeloma, symptomatic multiple myeloma, or recurrent multiple myeloma.

21. The method of claim 19, wherein said copy number abnormalities and altered gene expression, are detected by the methods comprising interphase fluorescent in situ hybridization, metaphase fluorescent in situ hybridization, PCR-based assays, protein-based assays, or a combination thereof.

22. A method of identifying therapeutic targets to treat a disease in an individual, comprising:
isolating plasma cells from individuals who suffer from a disease within a population and from individuals who do not suffer from a disease within a population;
extracting nucleic acid from said plasma cells;
hybridizing said nucleic acid to a comparative genomic DNA array and to a gene expression DNA microarray to determine copy number abnormalities and expression levels of genes in the plasma cells; and
performing data analysis comprising bioinformatics and computational methodology, to identify copy number abnormalities and altered expression of disease candidate genes, wherein said altered expression of disease candidate genes are identified to use as therapeutic targets to treat a disease in an individual.

23. The method of claim 22, wherein said disease comprises multiple myeloma or classifications thereof.

24. The method of claim 23, wherein said classification of multiple myeloma comprises monoclonal gammopathy of undetermined significance, asymptomatic multiple myeloma, symptomatic multiple myeloma, or recurrent multiple myeloma.

25. The method of claim 22, wherein said disease candidate genes are selected from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

26. The method of claim 22, wherein said altered expression of said disease candidate genes comprises gain of expression, reduced expression, or a combination thereof.

27. The method of claim 22, wherein said copy number abnormalities and altered gene expression, are detected by the methods comprising interphase fluorescent in situ hybridization, metaphase fluorescent in situ hybridization, PCR-based assays, protein-based assays, or a combination thereof.

28. A method of detecting diagnostic, predictive, or therapeutic markers of a disease, comprising:
isolating plasma cells from individuals who suffer from a disease within a population and from individuals who do not suffer from a disease within a population;
extracting nucleic acid from said plasma cells;
hybridizing said nucleic acid to a comparative genomic DNA array and to a gene expression DNA microarray to determine copy number abnormalities and expression levels of genes in the plasma cells; and
performing data analysis comprising bioinformatics and computational methodology, to identify copy number abnormalities and altered expression of disease candidate genes comprising loss of chromosome 1p DNA, loss of 1p gene expression, loss of 1p protein expression, gain of chromosome 1q DNA, gain of 1q gene expression, gain of 1q protein expression, gain of chromosome 8q DNA, gain of chromosome 8q gene expression, gain of chromosome 8q protein expression, or a combination thereof, wherein said altered expression of disease candidate genes comprises the detection of diagnostic, predictive, therapeutic markers, or a combination thereof, of a disease in an individual.

29. The method of claim 28, wherein said disease comprises multiple myeloma or classifications thereof.

30. The method of claim 29, wherein said classification of multiple myeloma comprises monoclonal gammopathy of undetermined significance, asymptomatic multiple myeloma, symptomatic multiple myeloma, or recurrent multiple myeloma.

31. The method of claim 28, wherein said disease candidate genes are selected from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA033, KIAA0406, KIAA0460, KIAA0859, KIAA1211, KIAA1219, KIAA1833, KIAA1920, KIF114, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A 7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF3JP3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ ZFP41, ZMYM2, ZNF267, ZNF364, ZNF488, or ZNF687.

32. The method of claim 28, wherein said altered expression of said disease candidate genes comprises gain of expression, reduced expression, or a combination thereof.

33. The method of claim 28, wherein said copy number abnormalities and altered gene expression, are detected by the methods comprising interphase fluorescent in situ hybridization, metaphase fluorescent in situ hybridization, PCR-based assays, protein-based assays, or a combination thereof.

34. A method to detect a need for interventional therapies to an individual with multiple myeloma comprising:
isolating plasma cells from individuals with multiple myeloma within a population and from individuals without multiple myeloma within a population;
extracting nucleic acid from said plasma cells;
hybridizing said nucleic acid to a comparative genomic DNA array and to a gene expression DNA microarray to determine copy number abnormalities and expression levels of genes in the plasma cells; and
performing data analysis comprising bioinformatics and computational methodology, to identify copy number abnormalities and altered expression of disease candidate genes, wherein said altered expression of disease candidate genes are identified and can be used to provide an interventional therapy to treat multiple myeloma in an individual.

35. The method of claim 34, wherein said multiple myeloma comprises monoclonal gammopathy of undetermined significance, asymptomatic multiple myeloma, symptomatic multiple myeloma, or recurrent multiple myeloma.

36. The method of claim 34, wherein said disease candidate genes are selected from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf18, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

37. The method of claim 34, wherein said altered expression of said disease candidate genes comprises gain of expression, reduced expression, or a combination thereof.

38. The method of claim 34, wherein said copy number abnormalities and altered expression of disease candidate genes, are detected by the methods comprising interphase fluorescent in situ hybridization, metaphase fluorescent in situ hybridization, PCR-based assays, protein-based assays, or a combination thereof.

39. A method of detecting copy number abnormalities, altered gene expression, and chromosomal regions to which the genes map to identify genomic signatures specific for a disease, comprising:
isolating plasma cells from individuals who suffer from a disease within a population and from individuals who do not suffer from the same disease within a population;
extracting nucleic acid from said plasma cells;
analyzing said nucleic acid to determine copy number abnormalities, altered gene expression, and chromosomal regions to which the genes map in the plasma cells; and
performing data analysis comprising bioinformatics and computational methodology to identify copy number abnormalities, altered gene expression, and chromosomal regions to which the genes map, wherein said copy number abnormalities, altered gene expression, and chromosomal regions to which they map is indicative of the genomic signature specific for said disease.

40. The method of claim 39, wherein said disease comprises multiple myeloma or classifications thereof.

41. The method of claim 40, wherein said classification of multiple myeloma comprises monoclonal gammopathy of undetermined significance, asymptomatic multiple myeloma, symptomatic multiple myeloma, or recurrent multiple myeloma.

42. The method of claim 39, wherein said disease candidate genes are selected from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A7, OR2A9P, OR4K15, OR52NI, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

43. The method of claim 39, wherein said altered expression of said disease candidate genes comprises gain of expression, reduced expression, or a combination thereof.

44. The method of claim 39, wherein said copy number abnormalities and altered expression of disease candidate genes, are detected by the methods comprising interphase fluorescent in situ hybridization, metaphase fluorescent in situ hybridization, PCR-based assays, protein-based assays, or a combination thereof.

45. The method of claim 39, wherein said chromosomal regions to which the genes map to comprise chromosomes 1, 2, 3, 5, 7, 8, 9, 11, 12, 13, 14, 15, 16, 17, 18, 19, 20, 21, 22, or a combination thereof.

46. A kit for the identification of genomic signatures linked to survival specific for a disease, comprising:
an array comparative genomic hybridization DNA microarray; and
a gene expression DNA microarray; and
written instructions for extracting nucleic acid from the plasma cells of an individual and hybridizing the nucleic acid to the DNA microarrays.

47. The kit of claim 46, wherein said DNA microarray comprises:
nucleic acid probes complementary to mRNA of genes mapping to chromosomes 1, 2, 3, 5, 7, 8, 9, 11, 12, 13, 14, 15, 16, 17, 18, 19, 20, 21, 22, or a combination thereof.

48. The kit of claim 46, wherein said genes are one or more from the group comprising ADAM5P, AGL, AHCTF1, AKR1C4, ALG14, ALPP, ANK2, ANKRD12, ANKRD15, ANKRD30A, APH1A, ARHGAP30, ARHGEF2, ARHGEF5, ARNT, ARPC5, ASAH1, ASPM, ATP8A1, ATP8B2, B4GALT3, BCAS2, BLCAP, BMS1P5, BOP1, C13orf1, C1orf107, C1orf112, C1orf19, C1orf2, C1orf21, C1orf56, C20orf43, C20orf67, C6orf118, C8 orf30A, C8orf40, CACYBP, CAMTA1, CAPN2, CCT3, CD48, CD55, CDC42BPA, CDC42SE1, CENPF, CENPL, CEP170, CEPT1, CFH, CHD1L, CHRNB4, CKS1B, CLCC1, CLK2, CNNM1, CNOT7, COG3, COG6, COL7A1, CREB3L4, CSPP1, CTAGE4, CTGLF1, CTNNA3, CTSK, CYC1, DAP3, DARS2, DBNDD2, DDR2, DEDD, DEFB4, DENND2D, DHRS12, DHX32, DIS3, DNAJC15, DUB4, ECEL1P2, EDEM3, EIF2C2/AGO2, ELAVL1, ELF1, ELK4, ELL2, ENSA, ENY2, EXOSC4, EYA1, FAF1, FAIM3, FAM20B, FAM49B, FANK1, FBXL6, FDPS, FFAR3, FLAD1. FLJ10769, FLJ12716, FLJ43276, FLJ45832, FNDC3A, FOXO1, FRMPD2L1, FRMPD2L2, GLRX, GNAI3, GON4L, GPATCH4, GPR89B, GSTM1, GSTM5, HBXIP, HHATL, HLA-DQB1, HLA-DRA, HYDIN, IARS2, ID3, IGH@, IGHA1, IGHG1, IGK@, IGKC, IGKV1-5, IGKV2-24, IGL@, IGLJ3, IGLV3-25, IGLV4-3, IGSF3, IGSF3, IL6R, ILF2, ISG20L2, IVNS1ABP, KBTBD5, KBTBD6, KBTBD7, KCTD3, KIAA0133, KIAA0406, KIAA0460, KIAA0859, KIAA1211, KIAA1219, KIAA1833, KIAA1920, KIF14, KIF21B, KIFAP3, KLHDC9, KLHL20, LCE1D, LCE1E, LCE3B, LCE3D, LOC200810, LOC441268, LPGAT1, LRIG2, LY6E, LY9, MANBAL, MAP1LC3A, MAPBPIP, MEIS2, MET, MLL3, MPHOSPH8, MRPL9, MRPS14, MRPS21, MRPS31, MSTO1, MTMR11, MYST3, NDUFS2, NEBL, NEK2, NET1, NIT1, NME7, NOS1AP, NUCKS1, NUF2, NVL, OPN3, OR2A1, OR2A20P, OR2A7, OR2A9P, OR4K15, OR52N1, PBX1, PCDHA1, PCDHA2, PCDHA3, PCDHA4, PCDHA5, PCDHA6, PCDHA7, PCDHA8, PCM1, PEX19, PHF20L1, PI4 KB, PIGM, PIGU, PLEC1, PLEKHA1, PMVK, POGK, POLR3C, PPM2C, PPOX, PRB1, PRCC, PRKG1, PSMB4, PSMD4, PTDSS1, PTPN20A, PTPN20B, PUF60, PYCR2, RAB3GAP2, RALBP1, RASSF5, RBM8A, RCBTB1, RCOR3, RGS5, RHCE, RHD, RIPK5, RNPEP, RPAP3, RRP15, RTF1, RWDD3, S100A10, SCAMP3, SCNM1, SDCCAG8, SDHC, SETDB1, SETDB2, SF3B4, SHC1, SIGLEC5, SIRPB1, SNRPE, SP1, SPEF2, SPG7, SS18, STX6, SUGT1, TAGLN2, TARBP1, TARS2, TBCE, THEM4, TIMM17A, TIPRL, TMEM11, TMEM183A, TMEM50A, TMPRSS11E, TNKS, TOMM40L, TPM3, TPR, TRAF31P3, TRBV5-4, TRIM13, TRIM33, TSC22D1, UBAP2L, UBE2T, UCHL5, UCK2, UGT2B15, UPF1, UTP14C, VPS28, VPS36, VPS37A, VPS72, WBP4, WDR47, WDSOF1, YOD1, YWHAB, YWHAZ, ZFP41, ZMYM2, ZNF267, ZNF364, ZNF488, or ZNF687.

49. The method of claim 46, wherein said disease comprises multiple myeloma or classifications thereof.

50. The method of claim 49, wherein said classification of multiple myeloma comprises monoclonal gammopathy of undetermined significance, asymptomatic multiple myeloma, symptomatic multiple myeloma, or recurrent multiple myeloma.
